(19) United States
(12) Patent Application Publication
(10) Pub. No.: US 2025/0158081 A1
(43) Pub. Date: May 15, 2025

(54) CURRENT COLLECTORS FOR RECHARGEABLE BATTERIES

(71) Applicant: ADDIONICS IL LTD, Tel-Aviv Yaffo (IL)

(72) Inventors: Moshiel BITON, Tel-Aviv Yaffo (IL); Vladimir YUFIT, London (GB); Farid TARIQ, London (GB); Nir HALUP, Tel-Aviv Yaffo (IL); Belen BELLO RODRIGUEZ, London (GB); Stanislav DERMAN, Tel-Aviv Yaffo (IL); Hanan MEUSHAR, Tel-Aviv Yaffo (IL); Enrique RUIZ TREJO, London (GB)

(21) Appl. No.: 18/834,752

(22) PCT Filed: Feb. 2, 2023
(86) PCT No.: PCT/IL2023/050119

§ 371 Date: Jul. 31, 2024

Related U.S. Application Data
(60) Provisional application No. 63/267,543, filed on Feb. 3, 2022.

(51) Int. Cl. H01M 4/74; H01M 4/02; H01M 4/131; H01M 4/136; H01M 4/505; H01M 4/525; H01M 4/58; H01M 4/66; H01M 10/0525

(52) U.S. Cl. CPC H01M 4/742; H01M 4/131; H01M 4/136; H01M 4/505; H01M 4/525; H01M 4/5825; H01M 4/662; H01M 10/0525; H01M 2004/021

(57) ABSTRACT

The present invention provides a foil with fine and uniform functional porosity that can be produced cheaply in roll-to-roll configuration, whereas the porosity stems from corrugation and/or perforation and of the foil. The presently disclosed augmented metallic foils are useful in many application, including, but not limited for use as current collectors in lithium-ion barratries.

### RELATED APPLICATION

This application claims the benefit of priority of U.S. Provisional Patent Application No. 63/267,543 filed 3 Feb. 2022, the contents of which are incorporated herein by reference in their entirety.

### FIELD AND BACKGROUND OF THE INVENTION

The present invention, in some embodiments thereof, relates to electrochemical cells, and more particularly, but not exclusively, to current collectors suitable for use in primary and secondary batteries.

Recently, a substantial century-defining change in power sources from engines to batteries has occurred in the automobile and renewable energy industry. Lithium-ion batteries (LIBs) play a central role as power sources, and post-LIBs have become of great interest as alternatives to LIBs. The rapid development of LIBs and post-LIBs with high performance parameters, such as a high charge/discharge cyclability, a high energy density, a high-rate performance, and a high safety of cells, is being strongly demanded. Efforts to meet the needs of high-performance LIBs have led to many developments involving anode, cathode, separator, and solid-state electrolyte materials that play major roles in improving battery performance. On the other hand, binders for combining anode and cathode active material particles, conductive additives that are mixed in anode and cathode layers, additives that are added to electrolyte solutions, and current collectors (CCs) are also needed to improve battery performance. Binders, additives, and CCs that have an improved matching to high-performance anode, cathode, separator, and electrolyte materials can enable the implementation of high-performance anode, cathode, separator, and electrolyte materials.

CCs play an important role in the charge/discharge process of batteries. CCs support active material layers for the anode and cathode, and they collect and distribute electrons to/from the active layers that are supported. To accelerate the electron transfer to/from the active layers, contact between the CC and active layer should be maintained during the charge/discharge process for thousands of cycles. The active layers should have a structure in which pathways for fast electron transport are spread over the active layer and Li⁺ ions can easily diffuse into the active layer. The CC structure should be designed to maintain the function of the active layer structure. At present, in commercially available LIBs, CCs have thicknesses of 10-12 μm and are flat planes. Copper (Cu) and aluminum (Al) foils are used as CCs for anodes and cathodes, respectively. In anodes and cathodes, Li⁺ ions and electrons should rapidly move to and from the anode and cathode particle surfaces to charge and discharge the cell, respectively, with a high current density. Therefore, in the anode and cathode layers, effective conductive paths for Li⁺ and electrons should be designed on planar CCs. In the present LIB preparation processes, a slurry composed of anode or cathode active material particles, a binder, a conductive additive, and a solvent is cast on the planar CC surface, and then the solvent in the slurry is evaporated to dry the anode and cathode layers formed on the CCs. Anode and cathode material particles are filled into the prepared anode and cathode layers. Binder and conductive additives are located in the spaces between the active material particles to bind the particles and to make electrical contact between the active materials particles. Electrolyte solutions containing Li⁺ ions permeate through the spaces. Li⁺ ions travel through the spaces permeated by the electrolyte solution to the anode and cathode active material particle surfaces. To increase battery performance, improved paths for the Lit and electrons should be constructed in the anode and cathode layers. In addition, CCs should have high mechanical strength, chemical and electrochemical stability, and adhesion between the active material layer and the CC surface. To realize these requirements, the optimization of materials for CCs, the structural modification of CCs, and the formation of a surface layer on CCs have been performed. Improvements in battery performance, such as the charge/discharge capacity, energy density, and capacity retention at a high current density and their stabilization could be obtained by a contribution from these factors.

Three-dimensional (3D) current collectors have been proven promising by realizing both high energy density and high-power density batteries. The exploitation of 3D current collectors in Li-based batteries benefit from the conductivity of interconnected 3D structure that guarantee the electrons and Li ion can rapidly transport/diffusion throughout the entire network, and from the mechanical strength and chemical stability gained by the microstructure, preventing the delamination of active material and the collapse or corrosion of the backbone, while maintaining flexibility and a large pore volume which can guarantee enough space to accommodate the volume expansion of active materials. Regardless the advantages of 3D current collectors, there are still some concerns to be addressed: 1) the large surface area usually induces high electrode/electrolyte interface area that causes significant consumption of electrolyte and Li species and consequently low Coulombic efficiency; 2) 3D porous current collectors still hold rather large volumes because of their disordered microstructures and low packing density, and their volumetric capacity is not comparable with those densely packed materials; 3) the requirement for high stability of the battery system requires the structure of 3D current collector to be strictly controlled; and 4) due to the complexity of the synthesis of 3D current collectors, the scale-up 3D current collector for real application is still out of reach economically; 5) since in the industry, the active materials are coated on metal foils by a roll-to-roll process, and the current collectors need to be weld to metal leads, small or single sheet-like 3D current collectors are not compatible with the downstream manufacturing process.

Nakamura, T. et al. [“Electrochemical performance of cathodes prepared on current collector with different surface morphologies”, J. Power Sources, 2013, 244, 532-537], report cathode electrodes prepared onto aluminum current collectors with different surface morphologies through usual doctor blade technique, and their electrochemical performances, especially at high current rate, which were influenced by the surface morphology of the current collector.

Wang, G. Q. et al., [“Investigation of the hole-formation process during double-sided through-mask electrochemical machining”, J. Mat. Processing Technology, 2016, 234, 95-101] report a through-mask electrochemical machining that has been developed to fabricate hole-array in titanium alloys that are difficult to cut using traditional mechanical machining.

Jeong, C. U. et al., [“Embossed aluminum as a current collector for high-rate lithium cathode performance”, J. Power Sources, 2018, 398, 193-200] report an aluminum foil prepared by an anodization process followed by chromate-phosphate treatment is evaluated for use as a current collector for a cathode powder prepared by the conventional electrode coating method.

Shan, W. et al., [“Three-dimensional Porous Current Collector for Lithium Storage Enhancement of NiO Electrode”, Acta Chim. Sinica, 2019, 77 (6), 551-558] report the fabrication of 3D porous metals that have been applied as current collector to improve the cycle stability and high-rate capacities of lithium-ion battery.

Loghavi, M. M. et al. [“Improvement of the cyclability of Li-ion battery cathode using a chemical-modified current collector”, J. Electroanal. Chem., 2019, 841, 107-110] reports an aluminum current collector that was treated by simple reacting an aluminum foil with a solution containing three acids, and the physical effect of this modification on surface of current collector was investigated through scanning electron microscopy (SEM) and contact angle test.

Choi H. et al., [“Fabrication of a Porous Copper Current Collector Using a Facile Chemical Etching to Alleviate Degradation of a Silicon-Dominant Li-ion Battery Anode”, Corrosion Science and Technology, 2021, 20 (5), 249-255] report a facile method to fabricate the three-dimensional porous copper current collector (3D Cu CC) for a Si-dominant anode in a Li-ion battery (LiB). The 3D Cu CC was prepared by combining chemical etching and thermal reduction from a planar copper foil.

JP2002216775A teaches a method of forming a current collector foil for an electrode of a secondary battery in which a large number of through holes are formed, wherein a non-elongated embossing roll having a large number of projections and a flat roll having no unevenness are provided.

WO2010011509A3 teaches an electrode material comprising a first electrode; and a current collector disposed adjacent to and bonded to the first electrode, wherein the current collector comprises a plurality of conductive protrusions extending in a z-direction from the current collector into the first electrode.

WO2010116872A1 teaches a method for manufacturing an electric storage device electrode that prevents electrode particles from being broken and a collector from being curved, and forming a plurality of grooves in one direction on the surface of the current collector.

WO2013157806A1 relates to a method for manufacturing an electrode for a secondary battery, including a step of performing surface treatment on a collector so as to provide a morphology forming a surface roughness (Ra) of between 0.001 μm and 10 μm over the entire surface and improved adhesion between the electrode active material and the collector, and an electrode for a secondary battery manufactured by using the method.

US20160197353A1 provides a perforated plate-shaped material has at least one through hole penetrating from a first main surface to a second main surface opposite thereto, and in its cross-sectional shape, it has a smallest width portion on the hole surface and a first main surface portion where the hole surface terminates on the first main surface and includes a first projecting curve portion between the first main surface portion and the smallest width portion, and at least a part of the first projecting curve portion has a surface property/shape of a non-hole surface on the first main surface.

CN206250289U is a utility model presenting a kind of collector that is formed with thickness direction surface embossed portion, embossed portion is distributed with multiple embossing, and inside of each periphery being embossed along the thickness direction of collector from the surface of collector to collector extends and formed in peripheral region the groove extended along the thickness direction of collector.

### SUMMARY OF THE INVENTION

The present invention provides a foil with fine and uniform functional porosity that can be produced cheaply in roll-to-roll configuration, whereas the porosity stems from corrugation and/or perforation and of the foil. The presently disclosed augmented metallic foils are useful in many application, including, but not limited to use as current collectors in lithium-ion barratries. The present invention provides augmented metallic foils that benefit from the advantages of elaborately-produced 3D metallic structures but without the limitation of cost, time and production size associated with state-of-the-art methods for metal processing. The functional porosity of a thin metal foil is increased by unique corrugation and perforation criteria and methodologies, presented hereinbelow, to levels that challenge 3D structures (e.g., metal foams), while maintaining and benefiting from the speed, cost and roll-readiness of thin foil production methods. There are several challenges facing modern current collector design, including:

Reducing the resistance of the current collector to improve the efficiency of the device; this is achieved by the provisions of the present invention that teaches the use of materials with low electrical resistance, such as copper, aluminum or nickel, and by designing the current collector with a low resistance path for the current to flow through.

Increasing the surface area of the current collector to improve its ability to collect electrical current; this is achieved by the present invention, e.g., through adding surface features such as through-holes, bulges and/or ridges.

Minimizing the cost of the current collector; this is achieved by the present invention through teaching the use of low-cost materials and by simplifying the production and design of the current collector to reduce manufacturing costs.

Ensuring that the current collector is compatible with the other materials and techniques commonly used in industrial settings; this is achieved by the provisions of the present invention, by teaching continuous production methods that afford current collectors that are not limited by size (length) and are therefore conducive to roll-to-roll coating processes.

The present invention relates to an object comprising a metallic member, characterized by a seamless repeating pattern of through-hole textural elements, and at least one of: (a) a seamless repeating pattern of non-piercing textural elements; (b) a local thickness that ranges 3-100 μm; and (c) a functional porosity (P_{f}) of at least 10%, wherein the metallic member is at least 0.1 m wide and at least 0.5 m long. The metallic member can be composed of a variety of metals including aluminum, copper, nickel, gold, cobalt, iron, titanium, steel, stainless steel, and any alloys and combination thereof. The object can be used as a current collector in an electrode of a battery. The invention also relates to a roll comprising a cylindrical core and the object wound around the core, and the object wound as a roll can have any length, up to thousands of meters.

Thus, according to an aspect of some embodiments of the present invention, there is provided an object that includes a metallic member, the metallic member is characterized by a seamless repeating pattern of through-hole textural elements, and at least one of:
(a) a seamless repeating pattern of non-piercing textural elements;
(b) a local thickness that ranges 3-100 μm; and
(c) a functional porosity (P_{f}) of at least 10%,
wherein the metallic member is at least 0.1 m in width (at least 0.1 m wide) and at least 0.5 m in length (at least 0.5 m long).

In some embodiments, the metallic member is characterized by (a).

In some embodiments, the metallic member is characterized by (b).

In some embodiments, the metallic member is characterized by (c).

In some embodiments, the metallic member is characterized by (a) and (b).

In some embodiments, the metallic member is characterized by (a) and (c).

In some embodiments, the metallic member is characterized by (b) and (c).

In some embodiments, the metallic member is characterized by (a), (b) and (c).

In some embodiments, the metallic member includes or consists of a metal selected from the group consisting of aluminum, copper, nickel, gold, cobalt, iron, titanium, steel, stainless steel, and any alloys and combination thereof.

In some embodiments, the local thickness of the object ranges 3-20 μm.

In some embodiments, the functional porosity is at least 50%.

In some embodiments, the through-hole textural elements in the seamless repeating pattern have an average opening size that ranges 10-200 μm.

In some embodiments, the seamless repeating pattern have a pore density that ranges 30-200 holes/mm².

In some embodiments, the seamless repeating pattern is characterized by uniformity of at least 5%.

In some embodiments, the object is characterized by a tensile strength of at least 20-45 MPa.

In some embodiments pertaining to the object provided herein:
the metallic member includes copper,
the seamless repeating pattern of through-hole textural elements includes a motif of a round hole having a diameter of less than 100 μm and a horizontal distance of less than 500 μm,
the seamless repeating pattern of non-piercing textural elements includes a motif of a round depression and/or a round bulge each having a diameter of less than 500 μm and a horizontal distance of less than 1000 μm,
the local thickness is less than 50 μm,
the functional porosity is at least 50%,
the width is at least 0.1-5 m, and
the length of the metallic member is at least 50 m.

In some embodiments pertaining to the object provided herein:
the metallic member includes aluminum,
the seamless repeating pattern of through-hole textural elements includes a motif of a round hole having a diameter of less than 120 μm and a horizontal distance of less than 1,000 μm,
the seamless repeating pattern of non-piercing textural elements includes a motif of a round depression and a round bulge each having a diameter of less than 500 μm and a horizontal distance of less than 1,000 μm,
the local thickness is less than 100 μm,
the functional porosity is at least 50%,
the metallic member is at least 0.1-5 m wide, and
the metallic member is at least 50 m long.

According to an aspect of some embodiments of the present invention, there is provided a roll that includes a cylindrical core and the object provided herein wound around the core.

In some embodiments, the width of the object in the roll ranges at least 0.1-5 m.

In some embodiments, the length of the object in the roll ranges at least 0.5-10,000 m, and up to tens of kilometers

According to an aspect of some embodiments of the present invention, there is provided a current collector, that includes at least one object, as provided herein.

According to another aspect of some embodiments of the present invention, there is provided an electrode that includes the current collector, as provided herein.

According to another aspect of some embodiments of the present invention, there is provided a battery that includes at least one electrode, as provided herein.

According to another aspect of some embodiments of the present invention, there is provided an electric device that includes at least one battery, as provided herein.

In some embodiments, the electric device is selected from the group consisting of an electric vehicle for transportation in air, land, water and/or space, a smartphone, a laptop computer, a media player, a power tool, a toy, a heating device, a colling device and an illumination device.

According to some embodiments of the present invention, an augmented metallic foil is made by electroforming. This foil has a pattern of through-holes that repeat seamlessly across the foil. To make this augmented metallic foil, a metal-deposition substrate with small non-conductive gaps (called lacunae) on its surface is used. The metal foil is then formed on this substrate, and the lacunae act as a template for the through-holes in the foil, so that they repeat seamlessly across the foil. In some embodiments, this augmented metallic foil further undergoes corrugation augmentation.

In some embodiments of the invention, a special type of foil called an “augmented metallic foil” is made to exhibit a pattern of small through-holes that repeat seamlessly across the foil. The process of making this foil involves using a mask with openings (called lacunae) to etch a metal foil therethrough. The lacunae act as a template for through-holes, so that they repeat seamlessly across the foil. In some embodiments, this augmented metallic foil further undergoes corrugation augmentation.

As used herein the term “about” refers to +10%. For example, “about 100 μm” includes 100 μm as well as 90 μm, 91 μm, 92 μm, 93 μm, 94 μm, 95 μm, 96 μm, 97 μm, 98 μm, 98 μm, 99 μm, 100 μm, 101 μm, 102 μm, 103 μm, 104 μm, 105 μm, 106 μm, 107 μm, 108 μm, 109 μm, and 110 μm.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrase “selected from the group consisting of” includes all members of the recited group, each member of the recited group, and all possible combinations. For example, selected from the group consisting of A, B, and C, includes A, only, as well as B, only, as well as C, only, as well as A and B, as well as A and C, as well as B and C, and as well as A, B, and C.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

When applied to an original property, or a desired property, or an afforded property of an object or a composition, the term “substantially maintaining”, as used herein, means that the property has not change by more than 20%, 10% or more than 5% in the processed object or composition.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying figures. With specific reference now to the figures in detail, it is stressed that the particulars shown are by way of example and for purposes of illustrative discussion of embodiments of the invention. In this regard, the description taken with the figures makes apparent to those skilled in the art how embodiments of the invention may be practiced.

In the figures:

FIGS. 1A-E present exemplary motifs (tiles) and their corresponding seamless repeating patterns;

FIG. 2 presents simplified illustration of the concepts of local thickness, minimal bounding box (MBB) thickness and functional prosperity;

FIG. 3 presents a schematic illustration of two tapered through-holes in a foil, showing the diameter of the hole at the foil's top side (d₁) being smaller that the diameter of the hole at the bottom side thereof (d₂);

FIGS. 4A-E present various non-limiting examples of members, or current collectors, according to some embodiments of the present invention, each exhibiting a different type of perforation augmentation of a metal foil;

FIG. 5 present nine non-limiting examples of seamless repeating patters afforded by corrugation augmentation, according to some embodiments of the present invention;

FIG. 6 presents a schematic illustration of an exemplary member exhibiting SRP of round-shaped depressions and bulges afforded by corrugation augmentation using isolated non-piercing textural elements, and showing the local thickness, and the bounding box thickness of the exemplary member, according to some embodiments of the present invention;

FIGS. 7A-C present schematic illustrations of coating schemes of an augmented metallic foil, according to some embodiments of the present invention, wherein the top cross-sectional illustration (FIG. 7A) shows an electrode that exhibits the same thickness as the total thickness (MBB thickness) of a corrugated foil member, similar to the middle illustration (FIG. 7B) that shows a perforated and corrugated member, and the bottom illustration (FIG. 7C) shows an electrode that exhibits a greater thickness compared to the total thickness (MBB thickness) of a corrugated member;

FIGS. 8A-B present micrographs acquired using an optical microscope, taken for an augmented metallic foil made of a 12 μm thick copper foil (FIG. 8A) and a 60 μm thick aluminum foil (FIG. 8B), each undergone corrugation augmentation in the form of hexagonally-arranged circular depressions horizontally spaced by about 500 μm apart from each other;

FIG. 9 presents a photograph acquired using Leica DVM6 optical microscope, taken for a 60 μm thick aluminum foil undergone perforation and corrugation augmentations in the form of hexagonally-arranged circular holes and depressions horizontally spaced by about 500 μm apart from each other, respectively; and

FIG. 10 presents a photograph acquired using Leica DVM6 optical microscope, taken for the dried layer of slurry applied on a corrugated aluminum foil, or a member according to some embodiments of the present invention, after the aluminum had been removed by acid etching, showing five protruding textural elements with four depressed textural elements pointing to the opposite side;

FIG. 11 presents a photograph acquired using Leica DVM6 optical microscope, taken for the dried layer of slurry applied on a perforated member made of aluminum, according to some embodiments of the present invention, after the aluminum had been removed by acid etching, showing several round protrusions made of active material which have formed in the voids where holes in the member used to be;

FIGS. 12A-B present the battery cycling results obtained for lithium-ion cells comprising corrugated current collects, according to some embodiments of the present invention, wherein FIG. 12A presents the measurement of retained capacity of the cell constructed using a corrugated CC as provided herein (scale of capacity is as a percentage of initial capacity), and FIG. 12B presents the measurement of internal resistance of the cell at various states of charge, while comparing the results to those obtain for a similar cell comprising conventional (flat, non-porous) current collectors;

FIGS. 13A-B present optical scans of 0.53 cm² samples of a perforated and flat (non-corrugated) augmented foils, manufactured using one of the continuous manufacturing processes described herein, wherein FIG. 13A shows an aluminum object having a local thickness of 20 μm, and an SRP consisting of a round through-hole motif with an average radius of 55.1 μm and standard deviation of 2.4 μm (uniformity of the SRP of 4.4% SD), and FIG. 13B shows a copper object having a local thickness of 22 μm, and an SRP consisting of a round through-hole motif with an average radius of 58.9 μm and standard deviation of 1.4 μm (uniformity of the SRP of 2.4% SD);

FIGS. 14A-B present SEM micrographs of a corrugated and perforated objects, showing a top view of a copper current collector having active material coated on one side thereof for demonstration purposes (FIG. 14A) and cross-section of an SRP-perforated aluminum current collector (FIG. 14B);

FIG. 15 presents a plot of the capacity retention versus cycle number with initial capacity of 35 mAh at 100%, measured in lithium-ion cells produced with perforated and corrugated CCs, according to some embodiments of the present invention;

FIG. 16 is a comparative plot showing the DCIRs as a function of a cycle life between two configurations, a cell constructed with conventional (pristine foil) CC, and a cell constructed with an augmented metallic foil, as provided herein;

FIGS. 17A-B presents photographs of an augmented metallic foil (metallic member), according to some embodiments of the present invention, comprising aluminum and exhibiting corrugation augmentation, wherein the local thickness is about 20 μm, the vertical distance (height) of the round budges (non-piercing textural elements) is about 72 μm, which is also the MBB thickness, the horizontal distant between textural elements is about 500 μm, wherein an entire roll of the augmented metallic foil is presented in FIG. 17A with a close-up insert, and the microscopic image showing the corrugation textural elements in FIG. 17B; and

FIGS. 18A-C presents photographs of an augmented copper foil, according to some embodiments of the present invention, exhibiting corrugation augmentation, wherein the local thickness is about 12 μm, the MBB thickness is about 100 μm, the horizontal distant between textural elements is about 500 μm, wherein an entire roll of the augmented metallic foil is presented in FIG. 18A, a close-up insert in FIG. 18B, and the microscopic image showing the corrugation textural elements in FIG. 18C.

### DESCRIPTION OF EMBODIMENTS OF THE INVENTION

The present invention, in some embodiments thereof, relates to electrochemical cells, and more particularly, but not exclusively, to current collectors suitable for use in primary and secondary batteries.

Before explaining at least one embodiment of the invention in detail, it is to be understood that the invention is not necessarily limited in its application to the details set forth in the following description or exemplified by the Examples. The disclosure is meant to encompass other embodiments or of being practiced or carried out in various ways.

As discussed hereinabove, current collectors are responsible for electrically contacting the anode and the cathode in a rechargeable battery, so that electrons can enter and exit the same in a way which charge balances the flow of ions, or lithium ions (Li⁺) specifically in case of lithium and lithium-ion batteries. As Li⁺ enters the cathode during a discharge, electrons must also enter the cathode to charge balance the cathode. Because Li⁺ conducts through an electrolyte which does not conduct electrons, electrons need another pathway into and out of the cathode and anode. Current collectors (CCs) provide this pathway. External electrical circuits (a “load”, e.g., a light bulb or an electric vehicle) are connected to a rechargeable battery through terminals that electrically contact the CCs.

Commercially available primary and secondary batteries traditionally use planar, flat metal foils, woven metals, or meshes, attached to the backside of the cathode and the anode as their CCs. These CCs are limited with respect to their capacity to support large amounts of active material, and limited is their ability to transport charges uniformly from the active material bulk and extract useful energy from large loadings active material. Lack of uniformity and other spatial inconsistencies are the main cause battery malfunction, failure and even dangerous outcomes, most due to delamination of the active material from the CC, formation of hot-spots, cracks and swelling.

While conceiving the present invention, the present inventors envisioned a CC for battery electrodes that can be manufactured, namely coated and integrated into battery manufacturing lines according to the industry requirements, standards, practices and machinery, and unlike other 3D CCs, will be manufactured rapidly and in any length (tens, hundreds and thousands of meters-long rolls), with cost comparable to a standard metallic foil having similar dimensions/mass. The present inventors have contemplated that corrugation can increase the surface area of a thin metallic foil, since a corrugated foil takes on a wavy/bumpy texture with a series of ridges and furrows which increases the total surface area of the foil as compared to a flat foil of the same size, because the wavy/bumpy texture creates more surface area for contact with the active material. It was also conceived that increasing surface area will be beneficial in structural materials where it can increase the bonding surface area between the foil and other materials. The inventors also contemplated perforation to increase the surface area of a thin metallic foil, afforded by creating a series of small holes or openings in the foil. Perforating a foil creates additional surface area by exposing the edges of the holes, which can be beneficial in improving eclectic pathways in current collectors and increase the efficiency of the electrochemical process that takes place in battery electrodes. Perforation allows the top and bottom active material layers applied on the CC to make contact through the holes, thereby also increases the bonding forces between active material and current collector.

While reducing the present invention to practice, the present inventors have demonstrated an augmented metallic foil having textural elements that increase its surface area and vacancy of its minimal bounding box (see below, functional porosity), such that the amount of active material that can be loaded thereon is far greater compared to a flat featureless metallic foil of similar dimensions/mass. The textural elements of the augmented metallic foil also shorten the electric pathways within the layer of active material that is deposited thereon, thereby improving contact and charge transfer parameters of an electrode using this augmented metallic foil as a CC.

Hence, set forth herein are augmented metallic foils that can be used as current collectors, wherein the later overcome the abovementioned shortcomings, and address some of the problems in the relevant field to which the instant disclosure pertains, as well as processes for making and using the same.

Thus, according to some embodiments of the present invention, there is provided a member, referred to herein as an augmented metallic foil, which is characterized by a combination of some or all of the following features:
made of a conductive material, preferably a metal;
exhibiting a seamless repeating pattern of non-piercing textural elements;
exhibiting a seamless repeating pattern of through-hole textural elements;
exhibiting a local thickness of less than 100 μm, or local thickness that ranges 3-100 μm;
a functional porosity of at least 10%, or more than 50%,
wherein the augmented metallic foil, or object, is at least 0.1 m wide and at least 0.5-200 m long, or otherwise at least a width thereof or a length thereof, is more than 0.5 m long.

### Augmented Metallic Foil:

As used herein, the terms “augmented” and “augmentation” refer to the improvement of some properties of an object that resembles a foil, compared to these properties in a comparable pristine metal foil, or an unaugmented foil, wherein the pristine foil and the augmented foil are each relevant in the context of an object used as a current collector in an electrode regardless of the process by which each is obtained. Depending on the embodiment, the term “augmented” encompasses the terms “expanded”, “extended”, “inflated”, “intensified”, “magnified”, “swollen”, “aggrandized”, “amplified”, “broadened”, “developed”, “dilated”, “distended”, “elaborated”, “lengthened”, “spread”, “stretched”, “widened”, and “blown up”.

One of the objectives of the present invention is providing augmented metallic foil that can be used effectively in industrial settings, inter alia to form electrodes for the battery industry as a current collector. The phrase “augmented metallic foil” is used interchangeably with the term “member” and the term “object”, and refer to the final product regardless of the process by which it is obtained, namely the term “augmented” is used as a pronoun rather than a verb, and does not mean necessarily that a pristine foil is a precursor of the final product.

In the context of embodiments of the present invention, a pristine metal foil is a very thin sheet of metal, typically made by rolling, hammering and/or electrochemical deposition. Herein and throughout, the term “pristine” is used to refer to an unaugmented foil, or to a precursor substrate of the member provided herein, according to some embodiments of the present invention, or to a step in the process of manufacturing the member, according to some embodiments of the present invention. In some embodiments, the term “pristine metal foil” refers to a non-porous, flat, smoot and planar metal foil, or to a non-augmented metallic foil.

In some embodiments, the augmented metallic foil (object; member) is made from a conductive metal. In some embodiments, the object comprises or consists of aluminum, copper, nickel, magnesium, cobalt, iron, titanium, platinum, tungsten and gold, and any alloy thereof, including steel, stainless-steel, carbonized/nitridized steel, bronze, electrum, pewter, brass and pig iron. In some embodiments, the alloys include magnesium, manganese, chromium, molybdenum, and vanadium, as well as semimetals and/or non-metal elements.

As used herein, the term “thickness” refers to the local thickness of a pristine foil or the thickness of a non-corrugated member, or to the thickness achieved by augmentation of a foil, according to some embodiments of the present invention.

In some embodiments, the object (member) is a corrugated foil, and its local thickness refers to a property of the flat pristine foil undergoing corrugation, and not to the thickness of the corrugated foil. Unless specified explicitly otherwise, the thickness of the corrugated object is the thickness of the minimal bounding box corresponding to the augmented object, as described hereinbelow.

In some embodiments of the present invention, the local thickness of the member provided herein is as thin as about 3 microns (μm), and in general the local thickness of the member less than about 100 μm, less than 90 μm, less than 80 μm, less than 70 μm, less than 60 μm, less than 50 μm, less than 40 μm, less than 30 μm, less than 20 μm, less than 15 μm, less than 10 μm, less than 9 μm, less than 8 μm, less than 7 μm, less than 6 μm, less than 5 μm, or less than 4 μm. In some embodiments, the local thickness of the member is about 3 microns μm, 4 μm, 5 μm, 6 μm, 7 μm, 8 μm, 9 μm, about 10 μm, 15 μm, 20 μm, 30 μm, 40 μm, 50 μm, 60 μm, 70 μm, 80 μm, 90 μm, about 100 μm, 110 μm, 120 μm, 130 μm, 140 μm, 150 μm, 160 μm, 170 μm, 180 μm, 190 μm, about 200 μm, 210 μm, 220 μm, 230 μm, 240 μm, about 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, or about 400 μm, or thicker. In some embodiments of the present invention, the thickness of the metal foil forming the basis for the member ranges. In some embodiments of the present invention, the local thickness of the member ranges 3-100 μm, 4-50 μm, 4-40 μm, 4-30 μm, 4-20 μm, or 4-10 μm 10-50 μm, 40-100 μm, 90-200 μm, 190-300 μm, or 290-400 μm.

In some embodiments the augmented metallic foil is a perforation-augmented metallic foil. In some embodiments the augmented metallic foil is a corrugation-augmented metallic foil. In some embodiments the augmented metallic foil is a metallic foil augmented by both perforation and corrugation.

In some embodiments the metal is aluminum, and the local thickness object ranges about 3-250 μm, 3-100 μm, 3-50 μm, 4-500 μm, 10-50 μm, 50-100 μm, or ranges about 100-250 μm. According to some embodiments of the present invention, the thickness of a smooth (planar, non-corrugated) member made of aluminum, or the local thickness of a member made of aluminum that is corrugated by a seamless repeating pattern (SRP) of non-piercing textural elements but not perforated, or the local thickness of a member made of aluminum that is SRP-corrugated and SRP-perforated, as defined herein, is less than 100 μm, less than 50 μm, less than 40 μm, less than 30 μm, less than 20 μm, less than 15 μm, less than 10 μm, less than 8 μm, or less than 6 μm.

In some embodiments the metal is copper, and the local thickness of the object ranges about 4-250 μm, 4-50 μm, 6-50 μm, or ranges about 10-100 μm. According to some embodiments of the present invention, the thickness of a smooth (planar, non-corrugated) member made of copper, or the local thickness of a member made of aluminum that is corrugated by a SRP but not perforated, or the local thickness of a member made of copper that is SRP-corrugated and SRP-perforated, as defined herein, is less than 100 μm, less than 50 μm, less than 40 μm, less than 30 μm, less than 20 μm, less than 15 μm, less than 10 μm, less than 8 μm, less than 6 μm, or less than 5 μm.

The member provided herein is augmented to increase its functional porosity, as presented hereinbelow. An augmented object may be thicker than its precursor pristine foil, and thus, in some embodiments, including any of the foregoing, the thickness (see below, MBB thickness) of the member is about 10 μm, about 20 μm, about 30 μm, about 40 μm, about 50 μm, about 60 μm, about 70 μm, about 80 μm, about 90 μm, about 100 μm, about 150 μm, 200 μm, 300 μm, 400 μm, 500 μm, 600 μm, 700 μm, 800 μm, 900 μm, or about 1 mm.

The local thickness of the member or object provided herein, can be measured using microscopy techniques such as scanning electron microscopy (SEM), optical microscope, micrometer or other method, unless specified otherwise.

In some embodiments, the metal foil is in a form of a long sheet having a fixed width and an unrestricted length, constrained only by practical limitations. In some embodiments, the metal foil has a width ranging from 10 cm to 5 meters, and a length of at least 0.5 meter, or at least 1 meter, or at least 2 meters, or at least 5 meters, or at least 10 meters.

In some embodiments of the present invention, the augmented metallic foil provided herein is produced as a single sheet, or as a continuous roll, using manual or automatic processes. Substrates herein may be metal meshes (i.e., perforated materials), dense metal layers, metal foils, or the like. The processes used to augment a metal substrate may be done at room temperature or by using heat to assist with the deformation process. The processes which use heating may be conducted in standard atmosphere or in an atmosphere with vacuum or with inert gas.

After a metal foil substrate is augmented, the augmented metallic foil (member) may be stacked on top of other members. In some embodiments, the augmented metallic foils are stacked to form a layered structure, and in some embodiments, the stacked members are bonded together. In some embodiments, the bonding is accomplished by diffusion bonding. In yet other embodiments, the bonding is accomplished by ultrasonic welding. In other embodiments, the bonding is accomplished by welding. In some embodiments, the stacked members are layered to afford a thicker object. In some embodiments, the layers are 1 μm, 5 μm, 10 μm, 25 μm, 50 μm, or 100 μm thick. WO2022064483A1 by the present assignee teaches methods of liquid cold welding (LCW) including: (a) engaging two or more porous conductive substrate layers between perforated non-conductive frames so that the substrate layers contact one another; (b) immersing the substrate layers in an electrolyte solution; and (c) applying electric current and/or voltage and/or electric power to the electrolyte solution. Apparatus suitable for performance of some embodiments of the method are also disclosed in WO2022064483A1.

In some embodiments, the member may be stacked on top of other metal substrates which have not been augmented. In some embodiments, the non-augmented metal substrates are stacked. In some embodiments, the non-augmented metal substrates are stacked and bonded together. In some embodiments, the bonding is accomplished by diffusion bonding, thermal welding, ultrasonic welding or electrochemical welding.

In some embodiments, the member is produced as a single sheet, with or without heating. In some embodiments, the member is produced as a continuous sheet, with or without heating.

In some embodiments, the metallic member provided herein is manufactured by a continuous process, discussed hereinbelow, and spooled into a roll. In some embodiments, the member is rolled into a cylindrical roll and having a width that ranges from 10 cm to 3 meters, and a length of at least 10 meters, or at least 100 m long.

The augmented metallic foil provided herein is designed for continuous manufacturing that typically results in a roll of the object, and further designed to be used in the form of a roll under industrial settings. Hence, the object provided herein is characterized by mechanical properties which render it producible and usable under industrial settings. One of these properties is tensile strength, which is sufficient to withstand the forces and stresses of pulling, winding, stretching and other operations used in the manufacturing process. The tensile strength required for a typical foil used for making current collectors for batteries in typical industrial settings will vary depending on the specific application and the type of foil, coating materials and battery. For example, a foil used for lithium-ion batteries typically has a minimum tensile strength of about 45

MPa (about 4.6 KgF/mm² in units of kilogram-force/square millimeter). The augmented metallic foil provided herein is different than a pristine foil in that also the augmentation features should also withstand the forces and stresses of being used in an industrial setting, and the object should not tear, and its textural elements should be preserved. In the context of some embodiments of the present invention, the object provided herein is characterized by a tensile strength of at least 20-45 MPa, or at least 60 MPa, at least 55 MPa, at least 50 MPa, at least 45 MPa, at least 40 MPa, at least 35 MPa, at least 30 MPa, at least 25 MPa, or at least 20 MPa.

### Seamless Repeating Pattern:

One of the objectives of the present invention is to provide an augmented metallic foil characterized by high uniformity of its textural elements and features essentially over its entire area, and therefore also the features of the augmentation are required to be substantially identical over the entire area of the foil. It is noted herein that the term “textural element” refers to a surface quality or feel of a material, such as its roughness, smoothness, or pattern. Textural elements are the visual aspects of a surface that give it a sense of depth and dimension. In the context of the present invention, the term “textural element” encompasses piercing (through-holes) and non-piercing elements (bulges; depressions).

A uniform distribution of fine textural elements (through-holes and/or non-piercing elements) can enhance electrical conductivity and reduce the resistance of the augmented metallic foil provided herein. To exhibit uniform augmentation, the augmented metallic foil provided herewith is characterized, inter alia, by a non-random, and purposely designed seamless repeating pattern (SRP) of textural elements conceptually spanning the entire area of the metallic foil without visible boundaries or irregular/arbitrary/random transitions between the repeating pattern motifs or within the motifs. In the context of the present invention, the augmented metallic foil is taken as an endless planar area, limited only by practical limitations.

As used herein, the term “patterned” with reference to a foil, refers to a non-random and purposely designed and engineered metal foil having, in some embodiments on the present invention, regularly-spaced and oriented textural elements on its surface. The features may be, but are not limited to, holes, peaks, valleys, defects, bends, twists, undulations, pores, or combinations thereof.

As used herein, the phrase “seamless repeating pattern”, abbreviated herein to SRP, refers to a pattern that spans an undefined and unlimited surface without visible transitions or boundaries. An SRP is an endless repeating pattern of textural elements that consists of repeating elements arranged in a two-dimensional format, such as a geometric shape or a decorative design. An SRP continues indefinitely in all directions, creating a seamless visual effect. This type of pattern is often used in textiles, wallpaper, flooring, and other decorative materials, as well as in graphic design, packaging, and branding. As discussed herein, an SRP can be defined by a repeating pattern unit, whereas placing a plurality of such units intimately adjacent (juxtaposed) to each other will afford the SRP. The repeating unit is referred to herein as a tile or a motif.

The motif is defined by one or more textural elements, whereas each motif blends into neighboring motifs to achieve the SRP. In the context of the present invention, the motif includes textural elements in the forms of holes (i.e., perforations, apertures, through-windows) or protrusions/indentations (i.e., bumps/depressions, bulges/creases, valleys/ridges), whereas the entire SRP can be defined by the motif. The arrangement of any given textural elements in the seamless repeating pattern characterizing the metallic member provided herewith is not random, as opposed to a random distribution of similar textural elements over a similar area, as explained below; hence, the SRP characterizing the metal foil provided herein is non-random by definition.

The coverage of a planar metal foil surface with the aforementioned SRP, essentially follows any standard tessellation or tiling approach, using one or more geometric shapes (tiles; motifs) with no overlaps and no gaps. While some embodiments of the present invention are drawn to a metal foil, which is essentially a two-dimensional entity if the thickness is disregarded, is noted that tessellation can be generalized to higher dimensions and a variety of geometries. In some embodiments, the SRP is afforded by a periodic tiling, whereas some embodiments include regular tiling with regular polygonal tiles, all having the same shape, and some embodiments include semiregular tiling with regular tiles of more than one shape and with every corner identically arranged.

The terms “motif” or “tile”, as used herein, refer to the smallest and simplest single textural element, or non-repeating group of textural elements, the repetition of which forms and defines the SRP. In the context of the present invention, a motif is closely related to a unit cell in a 3D lattice (a crystal/lattice), whereas the SRP is form by repeating the motif in the plane to any direction on the plane. Within a motif there can one textural element, or more than one textural elements. In some embodiments, the motif includes more than one textural elements that relate to one another by symmetry operations in the 2D plane, such as translation, rotation and reflection transformation operations. In some embodiments, the motif includes more than one textural elements that arranged non-symmetrically with respect to one-another, or more than one textural elements having different size/shape. A flat plane, or SRP, can be fully tiled (covered) with triangular, rectangular and hexagonal polygons (tiles), each having one or more textural elements arranged within. Rectangular and hexagonal tiles can be placed using the same tile orientation (only translation, no rotation), while triangular tiles are placed with a 60° rotation (translation and rotation).

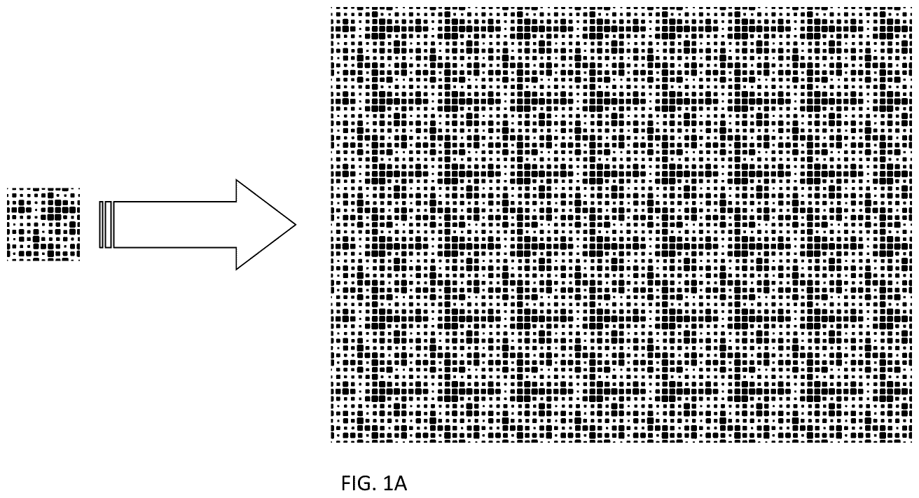

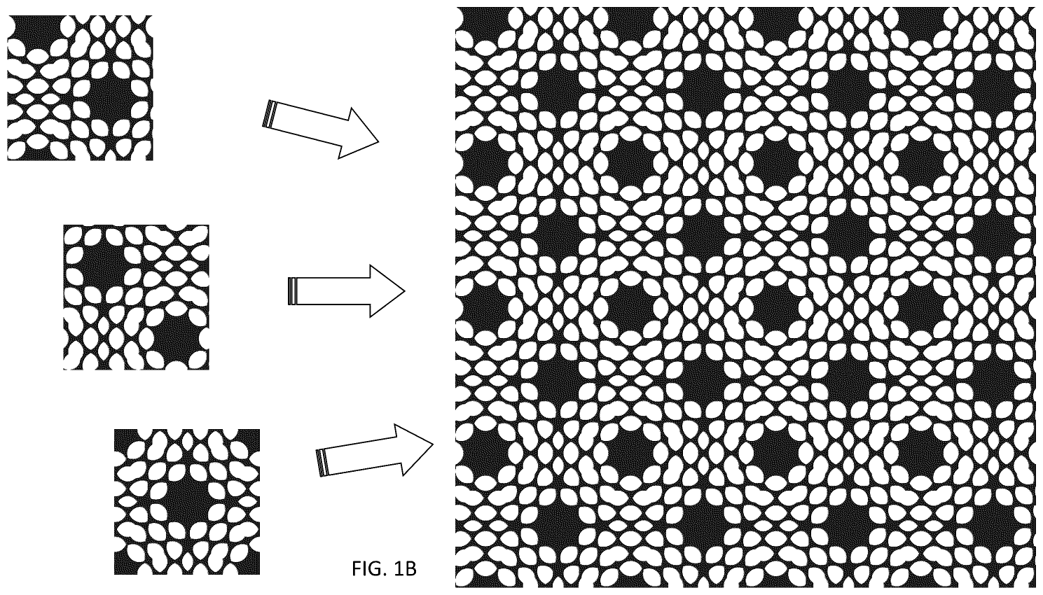

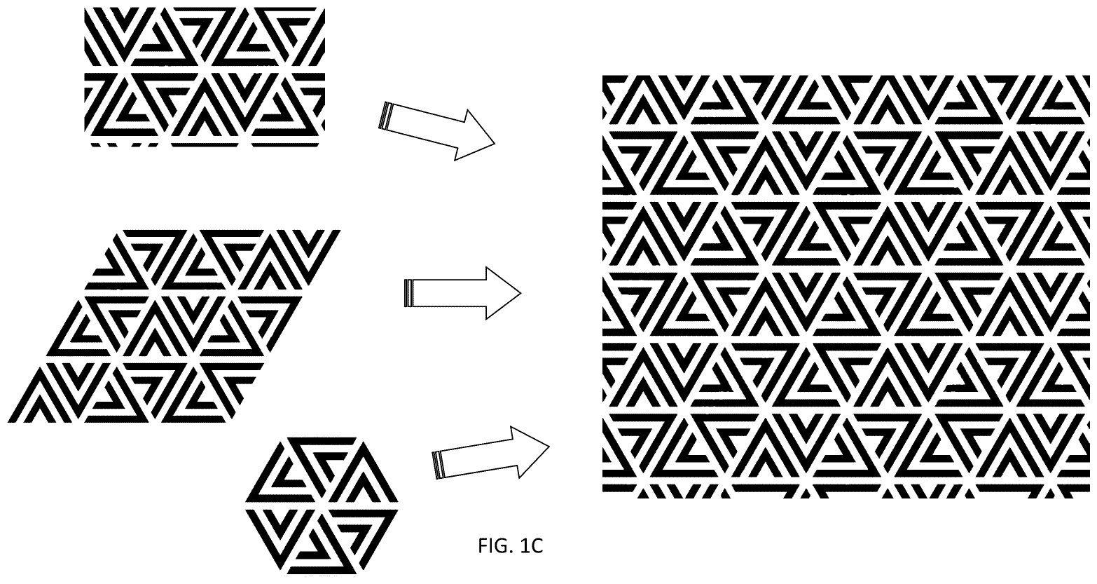

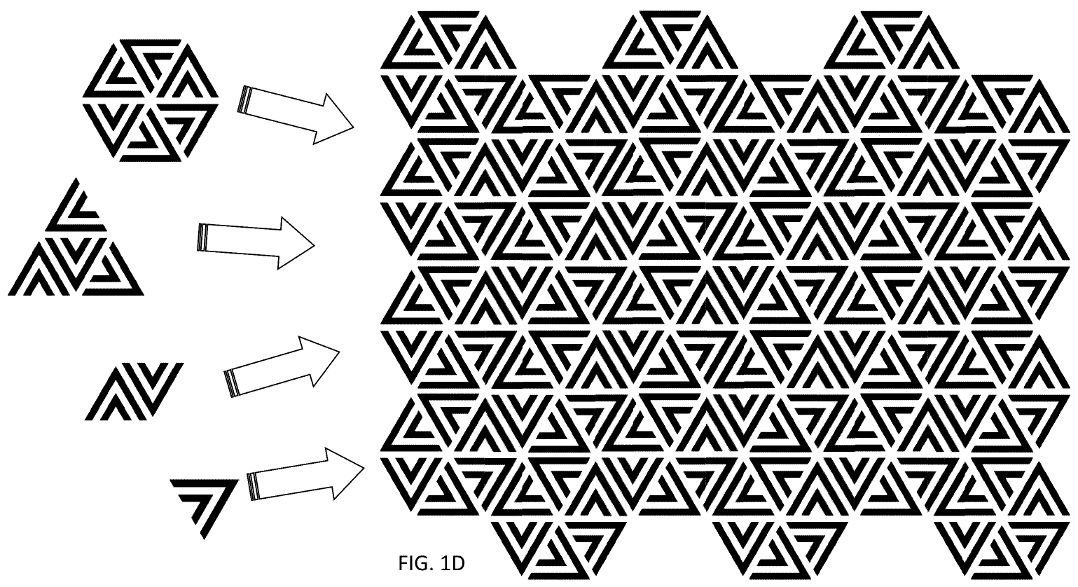

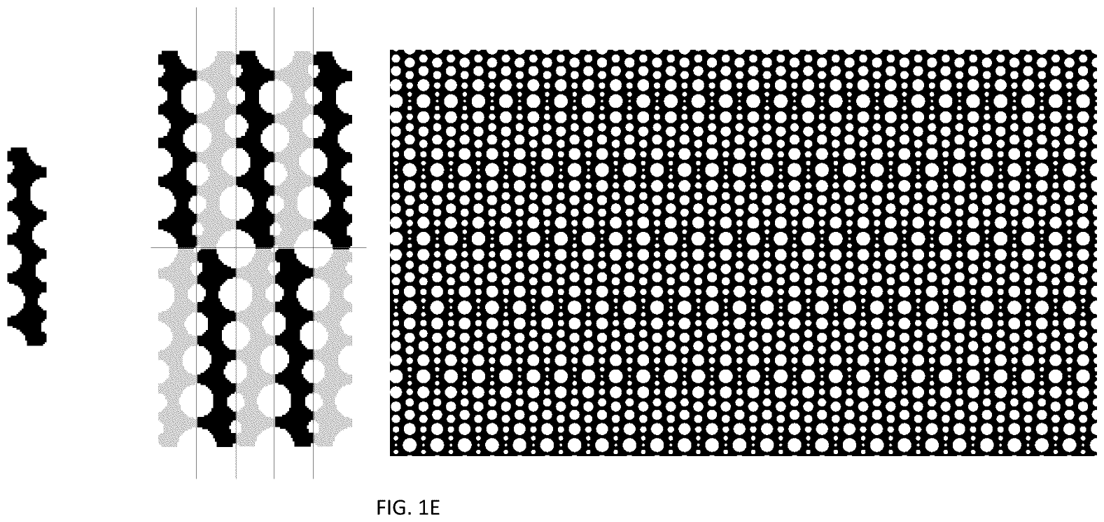

An example of a simple motif is a round dot, the expression of which can be a hole (perforation augmentation) and/or a bulge/depression (corrugation augmentation), whereas its SRP can be a square or hexagonal circle packing where the circles are evenly spaced, and in the case of through-holes, do not touch each other to allow continuous foil material therebetween). More exemplary and non-limiting embodiments of motifs and their corresponding SRPs, according to some embodiments of the present invention, are presented in FIGS. 1A-E.

FIGS. 1A-E present exemplary motifs (tiles) and their corresponding seamless repeating patterns, wherein FIG. 1A presents a square motif (left side) that exhibits round-cornered rectangular textural elements having various sizes arranged non-symmetrically within the tile, and the corresponding SRP resulting from endlessly repeating the motif over a plane; FIG. 1B presents three variations of a square motifs, two having a non-symmetric arrangement of textural elements and one having a symmetric arrangement (bottom left, 4-fold rotation) leading to the same SRP; FIG. 1C presents three variations of tile shapes, and the identical SRP resulting from endlessly repeating the motif over a plane by translation operation; FIG. 1D presents four variations of tiles, and the identical SRP resulting from endlessly repeating the motif over a plane by rotation and translation operations; and FIG. 1E presents a tile and its corresponding SRP resulting from endlessly repeating the motif over a plane by reflection, rotation and translation operations.

It is noted that the terms “textural element(s)”, “motif(s)”/“tile(s)”, and “seamless repeating pattern” (SRP) pertain to any type of foil augmentation, as these terms are discussed hereinbelow. In other words, the member is required to exhibit a seamless repeating pattern with respect to any of its textural elements, including through-holes, depressions/protrusions and/or creases.

Practically, in some embodiments, the augmented metallic foil exhibits the SRP over the entire area thereof, from edge to edge; in some embodiments, the SRP spans the major area of the foil, leaving narrow margins along its edges due to technical/practical requirements of industrial processing machinery. By margins, it is meant that the foil does not exhibit the SRP in the area regarded as the margins, wherein the foil can be pristine or have a different pattern than the SRP. In some embodiments, the margins extend on each edge of the metal foil, and in some embodiments, wherein the foil is a long sheet being more than 10-times longer than wide, the margins span less than 1%, less than 2%, less than 5%, or less than 10% of the total width of the metal foil. In some embodiments, one or more non-patterned strips are present near or at the center along the long axis of the member, designed for practical and industrial purposes, such as cutting the member to narrower strips. In such embodiments, the majority of the member comprises an SRP while narrow strips of pristine foil separate broad strips of SRP.

The seamless repeating pattern, according to embodiments of the present invention, is mathematically defined or constructed. In some embodiments, the SRP is generated by machine learning.

A roll:

The object provided herein is extremely thin, has a high surface area to volume ratio, and it is highly flexible, meaning it can be easily bent, folded, and shaped without breaking, and it can withstand a variety of stresses and forces. Hence, due to these properties, as well as the requirements of the manufacturing and utilization industries, one of the optimal formats to handle the object provided herein is in the form of a roll.

A roll of a long trip of the member provided herein can be described as a cylindrical shaped article, which is made up of a thin metallic object that has been wound around an axis. The roll is typically of a fixed width and can be of several tens, hundreds and even thousands meters in length. The roll can be packaged with protective materials to avoid any damage during the transportation and storage.

A roll of a foil is also characterized by a winding density. The winding density of a roll of foil refers to the compactness of the foil as it is wound onto the roll. It is a measure of how tightly the foil is wound around the core of the roll. The winding density is typically expressed as a ratio of the width of the foil to the diameter of the roll, and it is usually measured in units of width per unit of diameter (e.g., millimeters per millimeter or inches per inch). The winding density can be affected by a variety of factors such as the width of the foil, the thickness of the foil, the diameter of the core, and the tension applied during the winding process. A higher winding density results in a smaller diameter roll with a higher packing density of foil, while a lower winding density results in a larger diameter roll with a lower packing density of foil. The winding density is an important parameter in the manufacturing of foil rolls, as it affects the amount of foil that can be wound onto a roll and the overall size of the roll. It can also affect the handling and storage of the foil roll, as well as the performance of the foil in the application for which it is intended. Since the winding density correlates to the thickness of the MBB of the object provided herein, the winding density can be determined for a fix number of roll layers per MBB thickness, wherein a roll layer corresponds to one full winding of the foil around the roll. Hence, according to some embodiments of the present invention, the winding density of a roll, according to some embodiments of the present invention, ranges between at least 101-times the MBB thickness of the object per 100 roll layers to at least 150-times the MBB thickness of the object per 100 roll layers.

The augmented metallic foil provided herein can be rolled onto a core tube or a hollow cylinder having an inner diameter and an outer diameter which can be selected to suit the manufacturing and utilization settings.

Thus, according to an aspect of the present invention, there is provided a roll comprising a cylindrical core and an augmented metallic foil wound around the core. The roll is made up of a central cylindrical support, typically made of cardboard, plastic or metal, and the member provided herein is wrapped around the core. The core is typically hollow and provides the necessary support for the roll, while the member is the material that is used for producing, for example, electrodes for batteries. The roll can be of different sizes and the member can be of different thicknesses, depending on the specific application.

In some embodiments, a single continuous member provided in the form of a roll, has any fixed width, e.g., 0.1-5 meters wide, and any length, such as, for example, at least 0.5 m, 1 m, 10 m, 30 m, 50 m, at least 100 m long, at least 500 m long, at least 1,000 m long, or at least 0.5-100 m long, at least 50-500 m long, or at least 100-1,000 m long, and in some embodiments, at least 1-5 kilometer long.

An exemplary roll of corrugated aluminum with a local thickness 20 μm and a MBB of 70 μm would contain the following dimensions: width 193 mm, length 350 m+10 m, inner roll diameter 80 mm, and outer roll diameter 180 mm.

### Foil Augmentation:

The augmented metallic foil (the member) provided herein may be seen as a metal foil that has been augmented to increase surface area uniformly by being perforated as a mesh and/or corrugated as a checkered plate; these two forms of foil augmentation are referred to herein as a perforation augmentation and a corrugation augmentation, respectively, and the property that is being affected is referred to as “functional porosity”, as this term is defined hereinbelow.

In some embodiments, the member is corrugated, folded, protruded, bent, twisted, undulated, or a combination thereof (corrugation augmentation). In some embodiments, the member is perforated, pierced, punched, holed, emmeshed, or a combination thereof (perforation augmentation). According to embodiments of the present invention, the member exhibits corrugation augmentation, perforation augmentation or both perforation and corrugation augmentation simultaneously.

In embodiments where the foil exhibits more than one type of augmentation simultaneously, each of the types of augmentation is required to be uniform essentially over the entire area of the foil. In some embodiments, the uniformity of each of the type of augmentation is required to correspond to the size of the textural elements thereof, e.g., the standard deviation in terms of the size and shape of the textural elements, estimated by similarity between motifs (tile similarity).

As used herein, the term “size” refers to a characteristic dimension of an object or a textural element. When referring to the size of a plurality of objects, it refers to the average value obtained by measuring the size of a representative group of objects. A size of an object that is circular can refer to a diameter of the object. In the case of an object that is non-circular, a size of the non-circular object can refer to a diameter of a corresponding circular object, where the corresponding circular object exhibits or has a particular set of derivable or measurable characteristics that are substantially the same as those of the non-circular object. Alternatively, or in conjunction, a size of a non-circular object can refer to an average of various orthogonal dimensions of the object. Thus, for example, a size of an object that is an ellipse can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

### Functional Porosity:

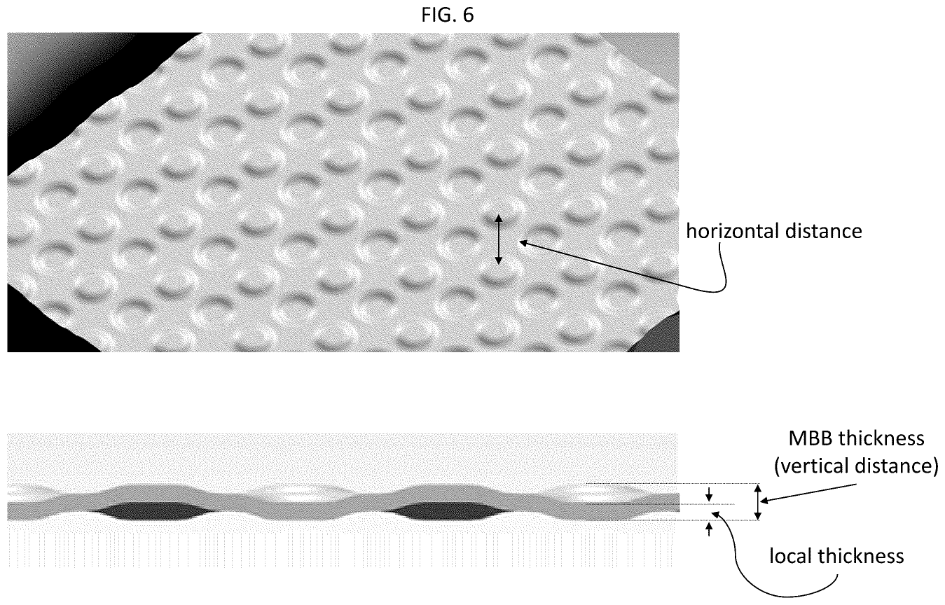

In the context of the present invention, an augmented metallic foil is said to have a non-zero functional porosity. As used herein, the phrase “functional porosity” refers to a structural property of an object that defines and quantifies the available volume within the minimal bounding box (MBB) of the object. A minimal bounding box is the smallest bounding cuboid of an object, as this geometric concept is known in the art. In the context of a foil that is defined as unlimited in width and length, the concept of a MBB refers to an arbitrarily chosen section, segment or piece of the foil, or refers to the thickness dimension, as shown, for example, in FIG. 6.

Available volume is considered to be all volume within the MBB that is not occupied by the material of the object. For a solid (non-perforated) foil, the calculation of the functional porosity (P_{f}) is calculated as defined in Equation 1:

$${P}_{f} = ( {T}_{b} - {T}_{1} ) / {T}_{b} . \qquad Eq . l$$

wherein T₁ is the thickness of the pristine (smooth) foil or local thickness, and Tb is the thickness of the corrugated member or MBB thickness.

For a more general example, such as a perforated and corrugated member, according to embodiments of the present invention, the functional porosity of the member (P, or P_{f}) is the volume fraction of the MBB that is not occupied by the member's substance, as defined in Equation 2:

$${P}_{f} = 1 - {V}_{m} / {V}_{b} \qquad Eq . 2$$

wherein Vₘ is the volume occupied by the member's substance and Vb is the volume of the MBB that includes member's substance and voids. Functional porosity can also be expressed as percent of thickness or volume. The volume of the member provided herein can be determined by dividing its mass by its density (m/cm³). Herein, the density of foil material is given in units of mass per unit volume. Hence, by noting the density of the member's material, measuring the mass of the member, and determining the volume of the MBB, the functional porosity of the member is calculated. For example, the functional porosity of a foil crimped to exhibit peaks and valleys, is higher that the functional porosity of a flat/smooth foil made from the same substance. In other words, a wrinkled foil would have a higher functional porosity compared to a flat/smooth foil, since a perfectly flat foil occupies 100% of the MBB, and its functional porosity is zero.

As used herein, functional porosity refers to a corrugated member (i.e., protrusions, bumps/depressions, bulges/creases, valleys/ridges) and/or a perforated member (i.e., mesh-like through-holes). For example, to calculate functional porosity of a perforated, flat and unwrinkled foil, or a flat mesh, one should consider that the thickness of the foil is much smaller than its width or length, however, the pores “expose” inner walls that allow access to a greater surface area of the foil, and in terms of volume, pores free-up space that otherwise would be occupied by the foil's substance. Hence, the functional porosity of a mesh having a finite thickness is higher than the functional porosity of a pristine (non-perforated) foil. It is evident that the density, shape and size of the pores (pore geometry) affects the functional porosity of a perforated member, and the thicker the foil is, the more profound is the effect of pore geometry on functional porosity. Similar to perforation, corrugation also increase the functional porosity of a member.

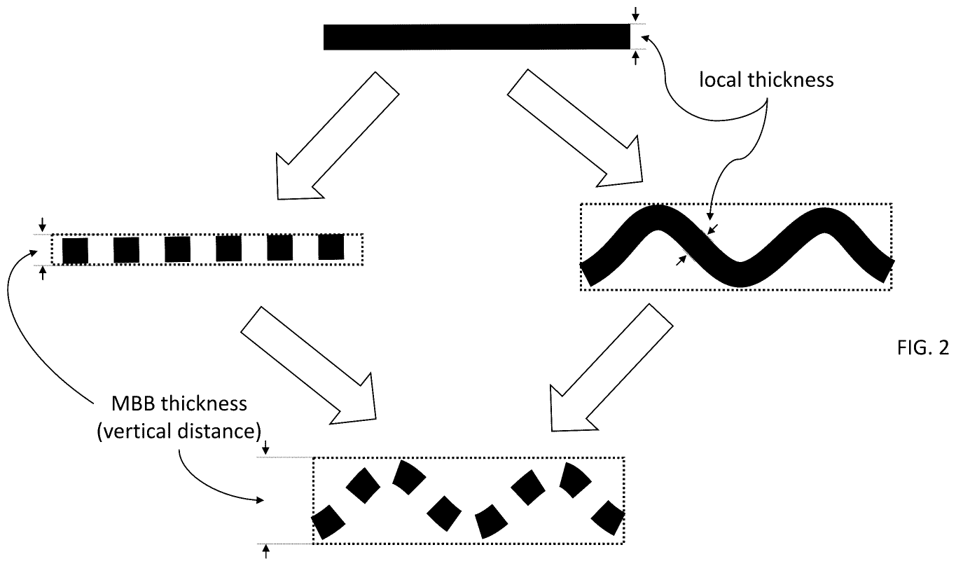

FIG. 2 presents simplified illustration of the concepts of local thickness, bounding box thickness and functional prosperity, wherein the straight horizontal thick black band (top) represents a longitudinal cross-section of a pristine foil having a given local thickness (shown on the right side of the cross-section), and showing the minimal bounding box (dotted-line rectangle) of the foil having perforation augmentation (left side), MBB of the foil having corrugation augmentation (right side), and the MBB and its thickness pertaining to the foil having both perforation and corrugation augmentations (bottom).

As can be seen in FIG. 2, each augmentation increases the free volume within the MBB, wherein the perforation augmentation increases the surface area within the MBB, and the corrugation augmentation also increases the volume of the MBB; as can further be seen, simultaneous perforation and corrugation augmentation increases the functional porosity to the maximum, when considering a foil as a basis for the member.

In some embodiments, the member provided herein is characterized by functional porosity of at least 5%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, 150%, 155%, 160%, 165%, 170%, 175%, 180%, 185%, 190%, 195%, or at least 200% and more. In some embodiments, the functional porosity the member ranges 5-100%, or 10-100%, or 50-150%, or 50-200%, or 100-150%, or 100-200% functional porosity.

### Perforation Augmentation:

Metallic meshes can be produced in a range of thicknesses, depending on the intended application and the manufacturing method used. In general, metallic meshes can be produced very thin, however, thinner mesh may be more prone to tearing or breaking, and may be less suitable for certain applications. There are several methods that can be used to produce thin metallic mesh, including electroforming, electroplating, rolling, weaving, stamping, and cutting and stretching. Each of these methods has its own set of advantages and limitations, and the optimal method depends on the specific requirements of the application. It is also possible to produce thin metallic meshes by etching or laser cutting a sheet of metal, which allows for the production of very fine, precise patterns in the mesh, however, these methods are very expensive and time-consuming, and therefore suitable for relatively small sheets, which are typically not suitable for industrial settings.

In some embodiments, the textural elements of the perforation augmentation are small pores, namely small through-holes. The terms “pore”, “hole”, “through-hole” (TH), thru-hole (TH), “clearance hole”, and “hole-type textural element”, are used herein interchangeably. According to embodiments of the present invention, the holes can take any shape and orientation, including round, rectangular, triangular, hexagonal, oval, diamond or odd shaped.

An alternative definition of the SRP describes the member as a foil having a patterned surface, wherein the patterned surface is a porous surface having a designed pore location distribution (PLD). In some embodiments, the pores are located at regularly spaced intervals on the member. In some embodiments, the member has different sized pores at different locations on the member. In some embodiments, the member has different types of pores at different locations on the member. In some embodiments, the member has different shapes of pores at different locations on the member. In some embodiments, the member has pores which are aligned in straight lines. In some embodiments, the member has pores which are aligned in lines which are tilted at an angle with respect to a side of the member.

As discussed hereinabove, augmentation of the metal foil follows a seamless repeating pattern, or SRP, which can be defined by tangent tiles or motifs within which the holes are the textural elements are positioned. An SRP is formed by filling the plane with the tiles. A tile may include a part of a (symmetric) hole, a single hole or any shape, or more than one hole of identical or different shapes (a mixture of shapes) and/or parts thereof.

A metal foil that is augmented by perforation that follows a seamless repeating pattern is also referred to herein as SRP-perforated member.

In some embodiments, a through-hole may have parallel walls, being perpendicular to the plane of the foil. In some embodiments, a through-hole may have slanted walls, making the one opening of the through-hole different in size and shape than the opposite opening of the same hole. For example, the space (void) defining a round hole may have the tapered shape of a trimmed cone, and the space defining a rectangular hole may have the tapered shape of a trimmed pyramid.

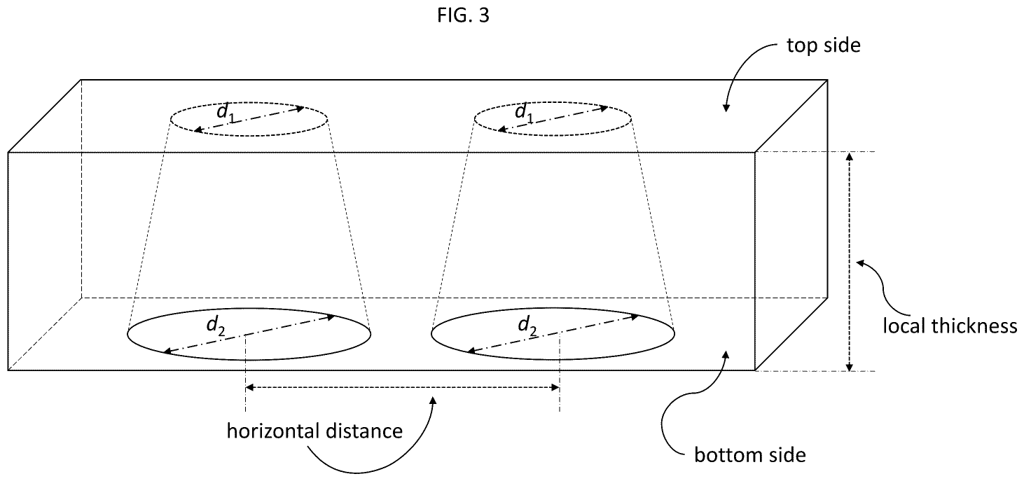

FIG. 3 presents a schematic illustration of two tapered holes in a foil having a local thickness, showing the diameter of the hole at the foil's top side (d₁) being smaller that the diameter of the hole at the bottom side thereof (d₂).

In some embodiments, the holes in a member having perforation augmentation are characterized by a tapered aperture, or in other words, the hole narrows from one surface side of the foil's plane to the other surface. It is noted that this though-hole morphology is typical to a process in which the augmented metallic foil is afforded by electroforming the foil on a conductive substrate that is surface-patterned with non-conductive lacunae, as SRP-template. In some embodiments, the member having perforation augmentation has a bottom side and a top side, and all the holes in the member are wider at the bottom side than at the top side of the member, namely all the holes taper to the same side of the member (see, FIG. 3). According to some embodiments, the tapering of the holes, in terms of apertures' diameter (or estimated size) reduction from bottom to top, is about 1-100% size reduction, or 1-50%, or 1-30%, or 1-20%, or 1-10% tapering (aperture size reduction). A 50% tapering (aperture diameter/size reduction) means that the surface of the bottom aperture is 50% larger than the top aperture. A 100% tapering means that the hole is closed at the top side of the foil, and the formation is a non-piercing textural element.

According to some embodiments, the diameter of the opening of the pores (opening size) of a member having a seamless repeating pattern of through-hole textural elements, as provided herein, can be as small as 10-200 μm. In some embodiments, the opening size of through-holes ranges from 10 μm to 5000 μm, or about 10-2000 μm, or about 10-1000 μm, or about 10-100 μm, or about 10-50 μm, or 20-100 μm, 30-100 μm, 40-100 μm, 50-100 μm, 60-100 μm, 70-100 μm, 80-100 μm, 90-200 μm, 90-300 μm, 90-400 μm, or about 90-500 μm. In some embodiments, the opening size of a through-hole textural element (hole; pore) is less than about 1,000 μm, less than about 750 μm, less than about 500 μm, less than about 250 μm, less than about 100 μm, less than 90 μm, less than 80 μm, less than 70 μm, less than 60 μm, less than 50 μm, less than 40 μm, less than 30 μm, less than 20 μm, less than 15 μm, less than 10 μm, less than 9 μm, less than 8 μm, less than 7 μm, less than 6 μm, less than 5 μm, or less than 4 μm.

In some embodiments, including any of the foregoing, the pores have an opening (aperture; opening size) dimension of about 1-100 μm x about 1-100 μm, or about 40 μm×50 μm, or about 52 μm×52 μm.

In some embodiments, the horizontal distance between the centers of two adjacent through-hole textural elements ranges 1-1000 μm, or about 10-100 μm, or 20-100 μm, 30-100 μm, 40-100 μm, 50-100 μm, 60-100 μm, 70-100 μm, 80-100 μm, or about 90-100 μm. In some embodiments, the horizontal distance between the center of two through-holes (pores) in the perforation augmented member is about 5 μm, 6 μm, 7 μm, 8 μm, 9 μm, 10 μm, 20 μm, 30 μm, 40 μm, 50 μm, 60 μm, 70 μm, 80 μm, 90 μm, or about 100 μm, 110 μm, 120 μm, 130 μm, 140 μm, 150 μm, 160 μm, 170 μm, 180 μm, 190 μm, or about 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, or about 400 μm, 450 μm, 500 μm, 550 μm, 600 μm, 650 μm, 700 μm, 750 μm, 800 μm, 850 μm, about 900 μm, 950 μm, or about 1,000 μm.

Pore density depends on the size of the holes and the horizontal distance between adjacent holes. In the context of the present invention, the pore density of a perforated member (or foil) relates to the number of through-holes per unit area. In some embodiments, the pore density relates to the ratio between substance (metal) area and void (hole) area per unit area. According to some embodiments, the pore density ranges from 30 holes per 1 mm² (square millimeter) to 200 holes/mm². Non-limiting examples of perforation augmentation are provided in terms of pore size, density and uniformity in the Examples section below.

The uniformity of the SRP of the perforation augmentation is determined by any experimental method, such as, for example, taking photographs of different sections of the member, scanning a pre-determined area within a photograph or in different photographs, identifying and digitizing the motifs in the scanned image and measuring the size and horizontal distance of a predetermined number of motifs per scanned section, and calculating the standard deviation in motif over across sections. In embodiments where the motif/tile encompasses a single hole, the SRP uniformity related to the standard deviation between individual holes. In embodiments wherein the motif/tile encompasses more than one hole, the SRP uniformity related to the standard deviation between motifs/tiles. In some embodiments, the standard deviation in motif overlap ranges 0-15%. In some embodiments, the standard deviation in motif overlap is less than 15%, less than 10%, or less than 5%.

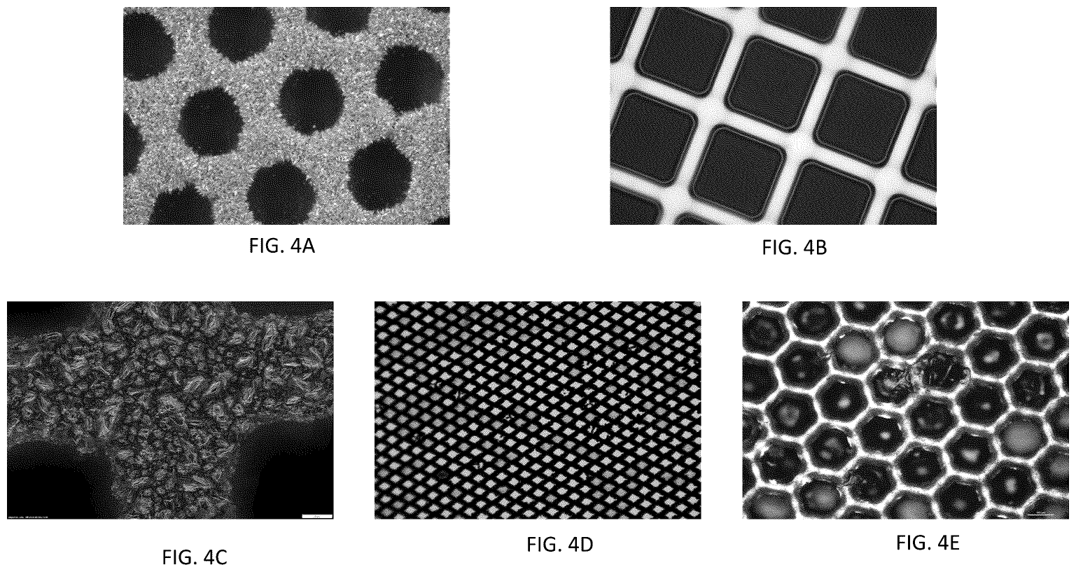

FIGS. 4A-E present various non-limiting examples of members, or current collectors, according to some embodiments of the present invention, each exhibiting a different type of perforation augmentation of a metal foil.

According to some embodiments of the present invention, the augmented metallic foil, comprising a seamless repeating pattern of through-holes, is being produced by electroforming a metal foil on a metal-deposition substrate having lacunae on its conductive surface, wherein the lacunae act as a template for the seamless repeating pattern of the through-holes in the deposited metal foil.

According to some embodiments of the present invention, the augmented metallic foil, comprising a seamless repeating pattern of through-holes, is being produced by electroetching a metal foil through a mask having lacunae (openings) therein, wherein the lacunae act as a template for the seamless repeating pattern of the through-holes in the etched metal foil.

### Corrugation Augmentation:

Corrugated metallic foils are used in a variety of applications, including in packaging materials, structural materials, and in electrical and thermal insulation. Corrugation in a thin metallic foil refers to the process of creating ridges or furrows in the foil in order to increase its surface adhesion and surface area, strength and stiffness. This is typically done by subjecting the foil to high pressure, which causes it to deform and take on a wavy or bumpy texture. The resulting corrugated foil is stronger and more resistant to bending and deformation with greater surface area than a flat foil of the same initial thickness.

In some embodiments, including any of the foregoing, the pristine or the perforated metal foil is rendered into a nonplanar patterned member (non-smooth embossed texture that stands out from the general plane of the foil), namely the foil is corrugated, folded, protruded, bent, twisted, undulating, or a combination thereof, jointly referred to herein as a nonplanar patterned foil, or a corrugated foil. As used herein, the term “nonplanar” refers to a substrate which is not flat, not smooth, not planar, not lying or able to be confined within a single plane, having a three-dimensional quality or which has some angle on its surface which is less than 180° or greater than 180°.

As used herein, the term “corrugation” refers to a plurality of both embossed and debossed textural elements that bestow a patterned texture, regular surface roughness and/or regular surface undulations. The term “corrugation”, as used herein, combines and encompasses both embossment and debossment, “dual-level embossing” and/or “dual-level debossing”, referring to the creation of both raised and recessed textural elements within the same design on a material. In some embodiments, the corrugation textural elements are regular in size, shape, spacing, and relative orientation. According to embodiments of the present invention, corrugation is defined as a plurality of non-piercing textural elements that are arranged in a seamless repeating pattern (SRP), wherein the term “non-piercing” refers to a discernible textural feature on the surface of a foil that is not a hole, and does not break the surface such that matter can pass through.

A metal foil that is augmented by corrugation that follows a seamless repeating pattern is also referred to herein as SRP-corrugated member.

Unlike through-holes, a non-piercing textural element, such as a crease, can span any length with respect to the size of the member, namely a crease can run from edge to edge while forming a part of a SRP of parallel creases. Further unlike through-holes, a non-piercing textural element can perturb the surface on one side thereof, and be a bulge (e.g., peak) or a depression (e.g., valley), depending on the definition of “top side” and “bottom side” of the member. Hence, non-piercing textural elements can be divided into a group of isolated elements, such that may form a single local bulge, and a group of extended elements, such that may form a ridge across the foil, ending at the edge of the foil.

Non-limiting examples of non-piercing textural elements include bulges, bumps, creases, depressions, peaks, protrusions, ridges, and valleys. The shape of a non-piercing isolated textural element can be defined by the “footprint” of the element on the surface of the foil, e.g., as it would look like from above. The shape of a non-piercing extended textural element can be defined by the cross-section of the foil perpendicular to the general direction of the element. For example, a simple round bulge/depression is an example of an isolated non-piercing textural element having a round (circular) shape, and undulating parallel ridges/valleys, or parallel wave in the shape of a sine (sinusoidal wave) are examples of extended non-piercing textural elements. Extended non-piercing textural elements may span the width of the member perpendicular to the longitudinal axis of the member, or in any angle with respect to the longitudinal axis, and parallel to the longitudinal axis of the member.

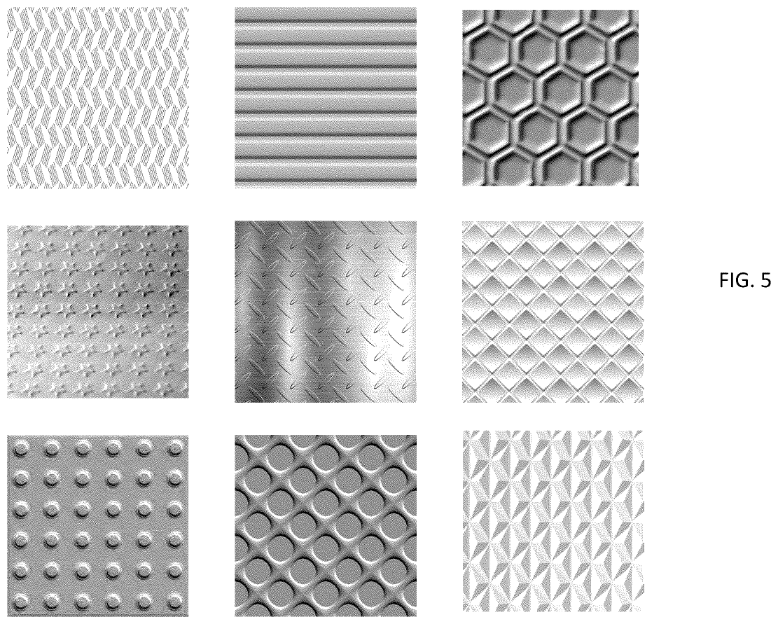

FIG. 5 present nine non-limiting examples of seamless repeating patters afforded by corrugation augmentation, according to some embodiments of the present invention.

FIG. 6 presents a schematic illustration of an exemplary member exhibiting SRP of round-shaped depressions and bulges afforded by corrugation augmentation using isolated non-piercing textural elements, and showing the local thickness, and the bounding box thickness of the exemplary member, according to some embodiments of the present invention.

Compared to the perforation augmentation of the metal foil provided herein, the textural elements of the corrugation augmentation may be smaller, similar or larger, and be defined by height as well as planar size and shape. The height of a corrugation textural element refers to the vertical distance from the bottom side to the top side of the member, or in other words, the thickness of the MBB. For example, a valley refers to a depression in the surface, and a peak refers to the mid-point of two adjacent valleys which extends above some portion of the surface. The peak to valley vertical distance or the peak to valley distance is the distance between the top of a peak and the bottom of an adjacent valley, and also the thickness of the MBB.

The horizontal distance (“horizontal pitch”) between textural elements (non-piercing or through-holes) is essentially the distance between the centers of two adjacent textural elements (see, FIG. 4 and FIG. 5). In some embodiments, the horizontal distance between the centers of two adjacent isolated or extended non-piercing textural elements in a corrugation augmentation ranges 1-1000 μm, or about 10-100 μm, or 20-100 μm, 30-100 μm, 40-100 μm, 50-100 μm, 60-100 μm, 70-100 μm, 80-100 μm, or about 90-100 μm. In some embodiments, the horizontal distance between the center of two non-piercing textural elements is less than about 1,000 μm, less than about 750 μm, less than about 500 μm, less than about 250 μm, less than about 100 μm, less than 90 μm, less than 80 μm, less than 70 μm, less than 60 μm, less than 50 μm, less than 40 μm, less than 30 μm, less than 20 μm, less than 15 μm, less than 10 μm, less than 9 μm, less than 8 μm, less than 7 μm, less than 6 μm, less than 5 μm, or less than 4 μm. In some embodiments, the horizontal distance between the center of two non-piercing textural elements is at least about 10 μm, 50 μm, 100 μm, 150 μm, 200 μm, 300 μm, 400 μm, 500 μm, 600 μm, 700 μm, 800 μm, 900 μm, or at least about 1,000 μm.

It is noted herein that in some corrugation processes wherein a thin foil is pressed against (or vice versa) a flat or rounded corrugation template in order to imprint the SRP of the template onto the foil, the foil's thickness may vary, depending on the type of corrugation employed. In some embodiments, corrugation is effected by mechanically expanding a perforated member. For example, if a perforated member is characterized by a functional porosity of 55% (45% of volume occupied by metal) and is 20 μm thick, and the perforated member (mesh) is pressed to exhibit corrugation textural elements, during which it is stretched to a local thickness of 100 μm (5-fold stretching), this reduces the metal portion in the member by a factor of 5 from 45% to 9%. This also increases the functional porosity from 55% to 91%. In some embodiments, the stretching is accomplished using embossing techniques. In certain examples, the stretched member is long and rolled up for use in factory assembly lines.

The above can be described numerically as follows:
P₍₀₎ is the functional porosity of a pristine foil or a flat perforated member;
P₍₁₎ is the functional porosity after corrugation (stretching);
M₍₀₎ is the fraction occupied by the metal in the pristine foil or the flat perforated member;
M₍₁₎ is the fraction occupied by the metal in the augmented metallic member;
T₍₀₎ is the local thickness of the pristine foil or the flat perforated member; and
T₍₁₎ is the local thickness after corrugation (stretching), hence M₍₀₎=1−P₍₀₎.

Since no material is added or removed during corrugation, then:

$${M}_{( 1 )} = {M}_{( 0 )} \cdot ( {T}_{( 0 )} / {T}_{( 1 )} ) , and$$

$${P}_{( 1 )} = 1 - {M}_{( 1 )} .$$

Thus, starting with P₍₀₎ of 50% and stretching by a factor of 4 affords P(1)=1-M( )=1-50%/4=87/5%. Start with P( )=80% affords P(1)=95%.

In some embodiments, stretching (local thinning) occurs mainly where the angle of textural element is the sharpest or where there is a drastic change in planarity. Such thinning, or stretching of the foil, may cause tears in the foil which can be designed deliberately-thereby forming a through-hole; otherwise, tears in the foil should be avoided. Hence, the magnitude of the corrugation textural elements also depends on the thickness of the foil and in some embodiments, the perforation of the foil which affects its tendency to tear under corrugation stretching.

In some embodiments, the ratio of the thickness of the MBB to the local thickness (the thickness of the pristine foil) is at least 1.1:1, at least 1.2:1, at least 1.3:1, at least 1.4:1, at least 1.5:1, at least 1.6:1, at least 1.7:1, at least 1.8:1, at least 1.9:1, at least 2:1, at least 2.2:1, at least 2.3:1, at least 2.4:1, at least 2.5:1, at least 2.6:1, at least 2.7:1, at least 2.8:1, at least 2.9:1, or at least 3:1. In some embodiments, the ratio of the MBB thickness to the local thickness ranges 1.1:1-2:1, or 1.1:1-3:1, or 1.1:1-4:1, or 1.1:1-5:1. In some embodiments, the MBB thickness is 5-10 times larger than the local thickness. The ratio of the thickness of the MBB to the local thickness is also an indication of the functional porosity on a non-perforated member having corrugation augmentation SRP, namely a 1.1:1 ratio corresponds to a functional porosity of 10%, and a 3:1 ratio corresponds to a functional porosity of 200%.

In some embodiments, the thickness of the MBB of the member having corrugated augmentation ranges from 6 μm to 5,000 μm. In some embodiments, the MBB thickness of the member having corrugated augmentation, or alternatively the vertical distance, is less than about 1,000 μm, less than about 750 μm, less than about 500 μm, less than about 250 μm, less than about 100 μm, less than 90 μm, less than 80 μm, less than 70 μm, less than 60 μm, less than 50 μm, less than 40 μm, less than 30 μm, less than 20 μm, less than 15 μm, less than 10 μm, less than 9 μm, less than 8 μm, less than 7 μm, less than 6 μm, less than 5 μm, or less than 4 μm. In some embodiments, the MBB thickness of the member having corrugated augmentation is at least about 5 μm, 10 μm, 20 μm, 30 μm, 40 μm, 50 μm, 60 μm, 70 μm, 80 μm, 90 μm, about 100 μm, 150 μm, 200 μm, 300 μm, 400 μm, 500 μm, 600 μm, 700 μm, 800 μm, 900 μm, 1,000 μm, 1,200 μm, 1,400 μm, or at least about 1,500 μm (about 1.5 mm).

In some embodiments, the size (diameter, footprint or widest horizonal span at the base of the textural element) of isolated non-piercing textural elements ranges from 10 μm to 5,000 μm.

In some embodiments, the size of an isolated non-piercing textural element is less than about 400 μm, less than 350 μm, less than 300 μm, less than 250 μm, less than 200 μm, less than 150 μm, less than 100 μm, less than 90 μm, less than 90 μm, less than 80 μm, less than 70 μm, less than 60 μm, less than 50 μm, less than 40 μm, less than 30 μm, less than 20 μm, less than 15 μm, less than 10 μm, less than 9 μm, less than 8 μm, less than 7 μm, less than 6 μm, less than 5 μm, or less than 4 μm.

In some embodiments, the corrugated SRP comprises extended textural elements, such as creases or undulation lines that run perpendicular to the longitudinal axis of the member, being a long and continuous sheet. In some embodiments, the extended textural elements cross the longitudinal axis diagonally.

In some embodiments, the corrugated SRP comprises isolated textural elements, such as bulges (convex), and depressions (concave), protruding on one size of the member (only bulges) or both sides of the member (bulges and depressions). In some embodiments, the isolated textural elements are aligned in straight lines. In some embodiments, the isolated textural elements are aligned in tilted lines, which are tilted with respect to the longitudinal axis of the member or one of its edges. In some embodiments, the isolated textural elements are arranged in tiles/motifs, as presented hereinabove and exemplified in FIG. 5.

In some embodiments, the textural elements of the perforation augmentation are much smaller and arranged more densely than the textural elements of the corrugation augmentation (10-100 times smaller). For a non-limiting example, a round through-hole, being the textural element of a mesh-type foil undergone perforation augmentation, is 10-100 times smaller than a bulge/depression being the textural element of that foil undergone corrugation augmentation; a member such as the aforementioned would have the appearance of a bumpy fine mesh/screen.

In some embodiments, the textural elements of the perforation augmentation are substantially similar in size compared to the textural elements of the corrugation augmentation, and in some embodiments are also similarly arranged. In some embodiments, the SRP of the perforation augmentation is aligned with the SRP of the corrugation augmentation, in which case the two SRPs are said to share frequencies.

The post-production uniformity of the SRP of the corrugation augmentation can determined by any experimental statistical method, similar to that used for the perforation augmentation or different. In some embodiments, the standard deviation in a corrugation motif overlap is less than 15%, less than 10%, or less than 5%.

### Continuous Manufacturing Processes:

The methods of making the member provided herein are conducive to producing a continuous SRP on or in a continuous metal foil, also referred to herein as a metal substrate, and include continuous additive manufacturing methods, continuous subtractive manufacturing methods, bonding methods, and in some embodiments, further include continuous post-manufacturing augmentation step(s). The present invention provides the means to produce a long, augmented metallic foil with high and uniform porosity cheaply and rapidly, which involve the enhancement of functional porosity of thin foils, such that these augmented foils provide the benefits of 3D structures (e.g., metal foams) while maintaining the benefits of uniformity (non-random SRP), speed of production, cost of production and roll-readiness gained from thin foil production methods.

The provisions of the present invention include the formation of a very thin and highly perforated foil in a single additive manufacturing step, namely the metallic member provided herein can be afforded at any length (up to kilometers long) in a single process step, already exhibiting some of the properties that define the object provided herein, such as the local thickness and the perforation augmentation under SRP conditions and uniformity requirements. In some embodiments, the additive manufacturing technique is electroforming, wherein the metal is deposited on a surface that serves as a substrate for metal deposition and foil-formation, while at the same time serving to confer the perforation augmentation under SRP conditions, as discussed hereinbelow. For example, copper can be deposited on a cylindrical surface having well-ordered arrangement lacunae, or small gaps, which are evenly spaced apart on the surface and are made of a non-conductive material. In the context of the present invention, this well-ordered arrangement is a template for a SRP, and the cylinder with conductive surface and small non-conductive lacunae can be used to form a thin metallic perforated foil with fine holes by an electroforming process. The lacunae serve as a template for the formation of the holes in the metallic member. The non-conductive material prevents metal deposition in those areas, creating holes in the metallic mesh that are about the same size and shape as the lacunae. This results in a fine through-hole seamless repeating pattern in the metallic member, reflecting the arrangement of the lacunae on the surface. According to some embodiments of the present invention, a perforated metallic member can also undergo corrugation augmentation to further increase its functional porosity, as presented herein, wherein the corrugation augmentation is effected by continuous, roll-to-roll setting, or as a step in the manufacturing of other products using the metallic member, such as electrodes.

The provisions of the present invention include augmenting a pre-formed thin metallic foil to exhibit perforation augmentation in a single subtractive manufacturing step, namely the metallic member provided herein can be afforded at any length (up to kilometers long) by introducing perforation to a foil already exhibiting some of the properties that define the object provided herein, such as the local thickness. The perforation augmentation step is conducted under SRP conditions and uniformity requirements. In some embodiments, the subtractive manufacturing technique is electroetching, wherein the metal is subjected to metal-etching conditions through a mask that exhibits apertures arranged under SRP conditions, causing selective removal of metal through the apertures, as discussed hereinbelow (through-mask or masked electroetching). For example, a thin aluminum foil can be subjected to masked electroetching through a mask having well-ordered arrangement lacunae, or small gaps, which are evenly spaced apart in the mask. In the context of the present invention, this well-ordered arrangement is a template for a SRP, and the lacunae serve as a template for the formation of the holes in the metallic member. This step results in a fine through-hole seamless repeating pattern in the metallic member, reflecting the arrangement of the lacunae in the mask. According to some embodiments of the present invention, a perforated metallic member can also undergo corrugation augmentation to further increase its functional porosity, as presented herein, wherein the corrugation augmentation is effected by continuous, roll-to-roll setting, or as a step in the manufacturing of other products using the metallic member, such as electrodes.

In some embodiments, including any of the foregoing, augmenting the metal foil, substrate or surface comprises increasing the available volume relative to a bounding-box total volume, or in other words, increase the functional porosity thereof.

In some additive manufacturing embodiments, a metal foil is electroformed. In some embodiments, a metal foil is electroformed on a mandrel, which may be flat or have other shapes, such as a cylindrical drum (cylinder). The terms “drum”, “cylinder” and “mandrel” are used herein interchangeably to refer to curved surface on which a metal foil can be formed, processed, and/or augmented, as described herein. In some embodiments, a metal foil is electroformed on a mold and a dielectric material fills, completely or partially, parts of the mold. In some embodiments, such a mold enables the creation of a non-planar material. In some embodiments, such nonplanar material can be dense/flat or have functional porosity (dense refers to a lack of pores).

In some subtractive manufacturing embodiments, a metal substrate is chemically etched. In some embodiments, a metal substrate is electroetched. In some examples, a metal substrate is electroetched on a cylindrical drum, or any other non-planar shape.

In some embodiments, a metal substrate is bonded via diffusion bonding, ultra-sonic welding, arc welding, electro-chemical welding to other metal substrates. In some embodiments, a metal substrate is deformed. In some examples, the substrate is a metal foil. In some examples, the substrate is a metal mesh.

In some embodiments, the metal substrates are rolled to further reduce their thickness. In some embodiments, after the metal substrates are either electroformed or etched (chemically or electroetching), the metal substrate further undergoes corrugation augmentation to increase its functional porosity.

In some embodiments, set forth herein is a process for making a member, wherein the process includes electroforming a metal structure on a mandrel, which may be flat or have other shapes, such as a cylindrical drum.

In some embodiments, including any of the foregoing, the process includes using a mandrel on which the electroforming of a structure is performed. In some embodiments, the mandrel have a flat surface or a patterned surface.

In some embodiments, patterning the mandrel's surface is achieved by machining, such as mechanical machining, etching, milling, laser machining, or any combination thereof.

In some embodiments, the process includes using forward and reverse current/voltage/power pulses and modifying pulse amplitude, shape, duration, and rate/frequency of pulses by modifying the pulse supply during the electroforming process to control the lateral growth of the metal and create a structure. In some embodiments, the process includes using direct current during the electroforming process.

In some embodiments, the shape of the pulses is not be symmetrical. In some embodiments, the shape, amplitude or duration of the pulse may change during the electroforming process, to specifically control the lateral growth at any stage of the metal deposition.

In some embodiments, including any of the foregoing, the process includes creating a perforated member via electroforming in which some parts of the working electrode are exposed, and some parts of the working electrode are covered by a dielectric material, whereas a dielectric material is non-conductive and the working electrode is a conductive surface where metal electrodeposition (plating) taking place. The parts on the surface of the working electrode that are non-conductive are also referred to herein as lacunae. Dielectric material may include various types of plastics, polymers, glues, epoxy resins and other non-conductive materials.

In some embodiments, pockets are machined, either mechanically, by laser, by a controlled chemical process or any other mean, and such pockets are then filled with a dielectric material.

This results in an electrochemical deposition (electroforming) of the metal occurring on the electric conducting mandrel surfaces but not on the non-conductive dielectric material, where a hole is formed, typically having a tapered void shape narrowing from bottom to top of the formed foil (see, FIG. 3).

In some embodiments, pockets are machined, either mechanically, by laser, by a controlled chemical process or any other mean, and such pockets are then partially filled with a dielectric material. This results in an electrochemical deposition (electroforming) occurring on mandrel surfaces that is not covered by dielectric material, including on the exposed part of inner walls of the pocket, resulting in a rimmed hole, having a tapered void shape, as seen in FIG. 3, and a rim around the wider aperture, raised above the surface of the foil. In this embodiment of the present invention and the likes, the continuous electroforming process is used to create textural elements that are both piercing the surface and protruding from the surface at the same time, or in the words, simultaneous perforation and corrugation augmentation by the same textural element.

In some embodiments, set forth herein is a process for making the member provided herein, wherein the process includes providing a metal foil having a patterned surface; and augmenting the metal foil such that the metal is nonplanar and has 5-98% functional porosity (corrugation augmentation).

In some embodiments, including any of the foregoing, the process includes providing a metal foil having a patterned surface wherein the metal is initially a planar surface but is transformed into a nonplanar metal by corrugation augmentation. The transformation may be accomplished using electric, mechanical, magnetic or other forces, or combination thereof.

In some embodiments, including any of the foregoing, the process includes providing a substrate in the form of a metal foil, a perforated metal foil (mesh) or a member having a perforation augmentation as provided herein, comprises applying localized mechanical forces to the substrate. In other embodiments, the corrugation augmentation includes using a metal tool (planar or drum) to press against the metal foil and thereby form non-piercing textural elements in the metal foil. In certain other embodiments, the process includes using a metal structure such as a template or substrate to press against the metal foil and thereby create nonplanar non-piercing textural elements in the metal foil.

In certain other embodiments, metal foils are modified using a process of stretching. In certain other embodiments, metal foils are modified using a process of stamping. In certain other embodiments, metal foils are modified using a process of twisting. In certain other embodiments, metal foils are modified using a process of corrugation. In certain other embodiments, metal foils are modified using a process of bending. In certain other embodiments, metal foils are modified at room temperature. In certain other embodiments, metal foils are modified at elevated temperature.

In some embodiments, including any of the foregoing, the process includes providing the member provided herein by deforming a metal substrate. In some embodiments, including any of the foregoing, the process includes augmenting the metal foil comprises applying a mechanical force to a metal substrate, e.g., a pristine thin metal foil or a perforated thin metal foil (SRP-perforated member). In certain embodiments, the process includes augmenting the metal by stretching a metal substrate. Herein, deforming includes modifying the shape of the metal substrate, modifying the porosity of a metal substrate, modifying the pore size of a porous metal substrate, modifying the pore shape of a porous metal substrate, or combination of two or more of the above. Herein, augmenting the substrate includes increase some physical dimension of the metal surface, e.g., its thickness and/or functional porosity. For example, augmenting the substrate may include increasing the size of pores in a porous metal surface. For example, augmenting the substrate may include increasing the surface area of the metal surface. Augmenting may include increasing the length or width of the metal surface. In yet other embodiments, augmenting the substrate includes stretching the metal so it is either longer or wider but is also thinner.

According to some embodiments of the present invention, the member provided herein may be manufactured by continuously electroforming (additive manufacturing) a member having perforation augmentation (e.g., a mesh). In some embodiments, including any of the foregoing, the continuous process includes providing a pristine metal foil by electroforming, and further augmenting the foil to comprise corrugation augmentation as described herein. In some embodiments, including any of the foregoing, the process includes providing a perforated member by electroforming on a patterned drum/mandrel, and further augmenting the perforated member to comprise corrugation augmentation as described herein, thereby affording a perforated and corrugated member, as described herein.

Electroforming herein includes processes of forming a mesh or solid using electricity (specifically, current, voltage or power). Electroforming includes electrodeposition in which metal ions are reduced to metal, wherein the metal has the shape of a mesh, or foil and thereby forms a mesh or foil. Electroforming may include the use of a template onto which the reduced metal is formed, wherein the template may be patterned or not patterned. In some embodiments, the template is flat. In some embodiments the template is curved, such as a drum/mandrel.

In some embodiments, the process for electroforming a mesh or a foil includes electroforming mesh or foil that comprises or consists of copper, nickel or zinc.

In some embodiments, the process for etching (chemical or electrochemical) a mesh or a foil includes etching mesh that comprises or consists of copper, aluminum, titanium, or steel/stainless-steel, and in general any metal conducive for etching.

Electroforming of copper on a drum is the standard production method used by the vendors which provide copper foils, such as used for current collectors in batteries. In some embodiments, including any of the foregoing, the equipment used for electroforming a metal foil is similar equipment to the equipment which is used for making screens for silk screen printing, screens for electric shavers and nickel meshes as filters, which are primarily used by the sugar making industry. In some embodiments, the tool or mandrel used for the electroforming of the member provided herein is reusable and conducive to continuous additive manufacturing the same. In certain other examples, the tool or mandrel used for the electroforming is not reusable.

In some embodiments, including any of the foregoing, the process further includes stretching a solid foil or a mesh; wherein the stretching also increases the pore size of the mesh. In other examples, this type of augmentation increases the length or width of the mesh. In yet other examples, this type of augmentation increases the length or width of the mesh and also decreases the thickness of the mesh. In some embodiments, a combination of the aforementioned type of augmentation steps are accomplished.

In some embodiments, the processes herein include a first step of making a metal mesh, or a member having perforation augmentation, either by continuous additive manufacturing or by continuous subtractive manufacturing, as presented hereinabove.

In some embodiments, the processes herein include a second step of increasing the functional porosity of the metal mesh or the member by corrugation augmentation. In some embodiments, a metal foil or perforated member, formed by continuous electroforming and/or continuous etching processes, is subjected to mechanical forces, which introduces non-piercing (corrugation) textural elements to the foil or mesh in a continuous manner.

In some embodiments, including any of the foregoing, the process includes augmenting the metal surface comprises etching a pattern onto the metal surface. In some embodiments, the etching is accomplished using neutral, acidic or alkaline etching solutions. In some embodiments, the etching is accomplished using electricity to oxidize the metal surface. In some embodiments, the etching is the combination of electric and chemical etching. In some embodiments, the etched pattern includes piercing (pores) and non-piercing (depressions) textural elements.

For aluminum electrochemical etching, an aqueous solution can be used with 0.5-3M NaCl and pH range between 0-5. A constant or pulsating positive voltage in the range of 3-20 V on Al for 5-600 sec can then be applied to aluminum substrate.

In some embodiments, the etching of a pattern onto the metal surface includes using a mask so that the pattern is etched through openings in the mask. The openings in the mask are also referred to herein as lacunae. In some embodiments, the mask is coated on the substrate that is to be etch. In some embodiments, the mask inserted between two electrodes, one of which is the foil, but does not contact either electrode. In some embodiments, the mask inserted between two electrodes but does not contact the substrate that is to be etched. In some embodiments, the mask attached to the counter electrode. In some embodiments, the etching is chemical etching. In some embodiments, the etching is electrochemical etching.

In some embodiments, including any of the foregoing, manufacturing the metal substrate includes electroforming or electroetching on a drum. In some of these embodiments, the drum is made of Al, Ni, Cu, Mg, Ti, steel, stainless steel, steel coated with chrome or other suitable metal, and in some embodiments the drum is made of a dielectric material.

In some embodiments, the diameter of the drum/cylinder/mandrel used for electroforming a metal foil or a member according to some embodiments of the present invention, or the diameter of the drum used for electroetching, each independently is about 100 mm, 200 mm, 300 mm, 400 mm, 500 mm, 600 mm, 700 mm, 800 mm, 900 mm, 1,000 mm, 200 cm, 300 cm, 400 cm, 500 cm, 600 cm, 700 cm, 800 cm, 900 cm, or about 1-4 m, about 2 m, 3 m, 4 m, or a diameter of about 5 m.

In some embodiments, including any of the foregoing, the drum/cylinder/mandrel has a patterned texture on its curved surface, arranged in an SRP around its circumference, wherein the elements of the patterned texture on the curved surface can be of any shape and size, according to the designed motif. In some embodiments, the elements of the patterned texture on the curved surface are approximately circular and have a diameter that ranges 1-500 μm. In some embodiments, the elements of the patterned texture on the curved surface have a diameter of about 1 μm, or a diameter of about 1-10 μm, 10-20 μm, 20-30 μm, 30-40 μm, 40-50 μm, 50-60 μm, 60-70 μm, 70-80 μm, 80-90 μm, 90-100 μm, 100-110 μm, 110-120 μm, 120-130 μm, 130-140 μm, 140-150 μm, 150-160 μm, 160-170 μm, 170-180 μm, 180-190 μm, 190-200 μm, 200-220 μm, 220-240 μm, 240-260 μm, 260-280 μm, 280-300 μm, 300-220 μm, 300-350 μm, 350-400 μm, 400-450 μm, or about 450-500 μm in diameter.

In some embodiments, including any of the foregoing, the elements of the patterned texture are present in the form of holes in the curved surface of the drum/cylinder/mandrel are at least 10-100 μm deep, at least 20-100 μm deep, at least 30-100 μm deep, at least 40-100 μm deep, or at least 50-100 μm deep. In some embodiments, including any of the foregoing, the holes in the drum/cylinder/mandrel are at least 10 μm deep, or at least 20 μm, 30 μm, 40 μm, 50 μm, 60 μm, 70 μm, 80 μm, 90 μm, or at least 100 μm deep, at least 110 μm deep, or at least 120 μm, 130 μm, 140 μm, 150 μm, 160 μm, 170 μm, 180 μm, 190 μm, or at least 200 μm deep, or at least 210 μm deep, at least 220 μm, 230 μm, 240 μm, 250 μm, 260 μm, 270 μm, 280 μm, 290 μm, or at least 300 μm deep.

Presently known subtractive manufacturing methods for perforating a metal foil of less than 100 μm thick, such as an aluminum foil, fail to provide fine textural elements, as currently provided by the present invention, namely the state-of-the-art technologies fail to form uniform holes of less than 50 μm in thin aluminum foils of less than 100 μm thick consistently and efficiently in a roll-to-roll mode. At best, the state-of-the-art technologies afford finite-size metal foil sheets (not unlimited length rolls) perforated with relatively large holes of more than 150 μm, which are not uniform (more than 30% variance in holes size) and have jagged edges. The state-of-the-art technologies include chemical etching through a photoresist mask that is applied on one or both sides of the foil, and etching is effected on one or both sides thereof, respectively. The state-of-the-art technologies also include metal foil perforation by electron beam emission or laser. These and other subtractive manufacturing approaches to foil perforation do not produce highly uniform patterns, and/or at best are slow and expensive, limited to manufacture relatively small sheets, and hence not conducive to unlimited length roll-to-roll mode of production and use.

The presently provided perforated metal foil was achieved by electrochemical etching, using electric current under certain chemical condition, to dissolve certain locations in a metal foil, atom by atom, from one side of the foil, using a mask. By choosing to perforate a metal foil with electrochemical etching rather than chemical etching, the present inventors achieved control over the process parameters, and thus uniform perforation patterns were achieved.

Briefly, electrochemical etching is afforded, inter alia, by tightening the metal foil on at least part of the circumference of the curved surface of a conductive cylinder, which serves as the anode in the electroetching process, so as to form an electrically conductive contact between the foil and the cylinder. In some embodiments, the anode is a flat surface, and in other embodiments, the anode is a curved conductive surface. A mask is placed on the exposed surface of the foil essentially over the area of the foil that is in contact with the anode, and a cathode, curved to match the curvature of the anode, is brought into close proximity (about 0.1-10 mm) from the mask, preferably 3 mm according to some embodiments, thereby forming a closed working space. Once the working space is sealed to act as a flow-cell, an electrolyte is continuously flown therein, a current is continuously applied between the anode and the cathode, thereby continuously etching the foil through the holes of the mask while the foil is continuously advanced through the flow-cell.

The challenge of seamless and endlessly repeating patterning was achieved by using a mask that was configured for continuous production mode, based on roll-to-roll architecture. This architecture, and the use of an SRP-conducive mask, enabled the production of “endless” perforated foil, overcoming the limitation of the state-of-the-art. In some embodiments, the mask is in the form of a closed band, which is tensioned directly on a narrow rolling section of the aluminum foil. In some other embodiments, a transitory mask is generated directly on the surface of the metal foil, e.g., by continuous printing an SRP-conducive mask on a narrow rolling section of the foil.

### Current Collector:

Current collectors (CCs) have general roles in battery systems: (i) because the typical electrodes are fabricated by casting slurry (a mixture of active material, polymeric binder, and carbon additive) on CCs, CCs support the electrode layer and (ii) CCs offer electrical paths to deliver electrons between the electrode materials and the external circuit. By controlling the properties of the CC, the following effects can be obtained: (i) the lower the thickness and the higher the strength, the more active materials can be stacked in a limited space, resulting in a high volumetric energy density; (ii) by strengthening the connection between the active material and CC with a broad contact area, additional electron pathways can be achieved, thus reducing the internal resistance of the cell. Generally, Cu and Al are applied as CCs for the anodes (0-1.5 V vs. Li/Li⁺) and cathodes (3-4.7 V vs. Li/Li⁺) respectively, because of their electrochemical stability in each reaction potential range and active material compatibility.

The present invention provides an augmented metallic foil, that exhibits high functional porosity and uniformity, thereby allowing loading larger amounts of active material slurry thereon, increasing the surface area of contact between the active material and the CC, and exhibiting uniformity over the entire area of the CC, thereby reducing delamination of active material, cracking, swelling, adverse formation of “hot-spots” and other mechanical failures that lead to battery malfunction.

A current collector with a large surface area and low density (low weight) can have several advantages in an electrode of a lithium-ion battery, compared to a solid flat and smooth foil current collector. Increased active material utilization: A larger surface area allows for more active material, such as lithium-ion, to be deposited on the current collector, leading to an increase in the overall energy density of the electrode. Improved conductivity: A high surface area current collector can have a greater electrical conductivity, which can improve the overall performance of the battery. Reduced weight: A low weight current collector can reduce the overall weight of the battery, making it more portable and convenient for use in applications such as electric vehicles and portable electronic devices. Better mechanical stability: A high surface area current collector can have a greater mechanical stability, which can improve the overall durability and longevity of the battery. Better rate capability: A high surface area current collector can have a greater rate capability which means the battery can be charged and discharged faster without diminishing its performance. Overall, a current collector with a large surface area and low density can improve the overall performance and efficiency of a lithium-ion battery.

In some embodiments of the present invention, the augmented metallic foil acting as a current collector with a large surface area and low density (high functional porosity), provides the following advantages:
(i) the lower the thickness and the higher the strength, the more active materials can be stacked in a limited space, resulting in a high volumetric energy density;
(ii) by strengthening the connection between the active material and CC with a broad contact area, additional and shorter electron pathways can be achieved, thus reducing the internal resistance of the cell; and
(iii) low-cost and rapid continuous manufacturing and provision in industrial-size rolls, conducive to the machinery and processes employed in contemporary and advanced electrode and battery industry.

Thus, according to an aspect of some embodiments of the present invention, there is provided a current collector, in the sense of a part of an electrode that collects electrons from electrode materials and transports them to an external circuit, wherein the CC consists or comprises the augmented metallic foil (member) provided herein.

As used herein, the term “current collector,” refers to a substrate that conducts electrons in a sufficient manner to be used in a battery or electrochemical cell to complete an electrical circuit at the cathode and anode. The CC is typically made of a metal such as copper, aluminum or nickel. Other metals such as magnesium, tungsten, cobalt, iron, titanium, platinum, tungsten and gold, and any alloy thereof, may also be used, as well as alloys or combinations of metals, such as steel. In the context of a secondary battery, the CC in the cathode conducts electrons into the cathode during a discharge and conducts electrons out of the cathode during a charge, whereas in an anode, the CC conducts electrons into the anode during a charge and conducts electrons out of the anode during a discharge.

A current collector may further include contacts and contact leads, terminators and other features common and/or needed as part of a current collector, or needed for its assembly and implementation in an electric device, and these additional features, all or any selection thereof, are encompassed in the definition of a current collection, as used herein.

In some embodiments, the current collector includes or consists of a member undergone perforation augmentation (e.g., a mesh), as defined and exemplified herein.

In some embodiments, the current collector includes or consists of a member undergone corrugation augmentation, as defined and exemplified herein.

In some embodiments, the current collector includes or consists of a member undergone perforation and corrugation augmentation, as defined and exemplified herein.

In some embodiments, including any of the foregoing, the current collector is provided in the form of a roll, as this term is defined hereinabove.

In some embodiments, the current collector provided herein comprises distinct metallic layers (strata). Herein, distinct layers are defined as a plurality of layers of metal which are discernible from one another under microscopy imaging conditions. If the layers are melted, bonded, welded, soldered or diffused together or into each other, such that no boundaries between them are observable under microscopy imaging, then the layers are not distinct. If, however, the layers are bonded together in such a way that a boundary between them is discernable under microscopy imaging, then the layers are said to be distinct.

In the context of the present invention, and particularly in the context of a multi-layered current collector, a layer includes or consists of an augmented metallic foil, as provided herein. For example, a CC may be 100 μm thick in total and include five discernable layers, each layer 20 μm thick, whereas these five layers when stacked on top of each add up to a total thickness of 100 μm. In some embodiments the metal layers may be porous or non-porous, and each may be, independently, corrugated, perforated or both perforated and corrugated.

In some embodiments, including any of the foregoing, the CC comprises distinct layers, each of which is independently characterized by a total thickness (MBB thickness) that ranges about 4-20 μm, or 5-20 μm, or about 10-50 μm.

In some embodiments of the present invention, the CCs are made by stacking individual members, as provided herein, as layers of metal, and further characterized by non-discernable layers (the layers are not distinct from each other).

In some embodiments, including any of the foregoing, the SRP of the CC includes 20-200 μm diameter pores. In some embodiments, the SRP of the CC includes 15-500 μm diameter pores. In some embodiments, including any of the foregoing, SRP of the CC includes 50 μm diameter circular pores; 90% functional porosity; and wherein the CC is 100 μm thick (MBB thickness).

In some embodiments, including any of the foregoing, the pores have a rectangular or polygonal-shaped opening. In some embodiments, the pores have an opening dimension of about 40 μm×50 μm. In some embodiments, the pores have an opening dimension of about 52 μm×52 μm. In some embodiments, including any of the foregoing, the CC includes 50 μm×50 μm squared-shaped pores; 90% functional porosity; and wherein the CC is 100 μm thick.

According to an aspect of some embodiments of the present invention, there is provided a current collector suitable for use in an electrode, such as e.g., in a battery, which includes at least one augmented metallic foil, as presented herein, wherein the augmented metallic foil is produced by a continuous manufacturing process such that it can be produced at width of at least 0.1 m and an unlimited length of at least 0.5 m, and characterized by at least some of the following characteristics:
a seamless repeating pattern of non-piercing textural elements;
a seamless repeating pattern of through-hole textural elements;
a local thickness that ranges 4-100 μm; and
a functional porosity of at least 10%.

### Corrugated Current Collectors:

According to an aspect of some embodiments of the present invention, there is provided a current collector suitable for use in an electrode, such as e.g., in a battery, which includes at least one augmented metallic foil, as presented herein, wherein the augmented metallic foil is produced by a continuous corrugation process such that it can be produced at width of at least 0.1 m and an unlimited length of at least 0.5 m, and characterized by:
a seamless repeating pattern of non-piercing textural elements (corrugation SRP);
a local thickness that ranges 4-100 μm; and
a functional porosity of at least 10%.

In some embodiments, the current collector comprises or consists of an augmented metallic foil (member) that is produced by any continuous manufacturing technique known in the art, and includes a continuous corrugation process step, which imparts corrugation augmentation the member, as these terms and features are described hereinabove.

Unless stated otherwise, the member is corrugated but not perforated, namely it is not a mesh. In such embodiments, the corrugation SRP may include isolated non-piercing textural elements and/or extended non-piercing textural elements, as defined hereinabove, which bring the functional porosity of the corrugated member to more than 10%, as presented herein.

In some embodiments, the size (diameter, widest span at the base) of isolated non-piercing textural elements in the SRP of the corrugated member ranges from 10 μm to 5,000 μm or 10-500 μm. In some embodiments, the horizontal distance between non-piercing textural elements in the SRP of the corrugated member ranges 100-5000 μm, or 100-500 μm.

In some embodiments, the horizontal distance between two adjacent non-piercing textural elements in a corrugation augmentation ranges 1-2000 μm, or about 10-100 μm.

The height of a corrugation textural element, characterizing the member in such embodiments, can be expressed in terms of the ratio between the local thickness and the MBB thickness, wherein the MBB of a non-corrugated foil is equal to its local thickness of its initial thickness before corrugation. In such embodiments, the ratio of the thickness of the MBB to the local thickness (the thickness of the pristine foil) is at least 1.1:1-2:1. In some embodiments, the ratio of the MBB thickness and local thickness is at least 3:1, 4:1, 5:1, 10:1, or at least 20:1. For example, a pristine foil having a local thickness of 10 μm can be augmented by corrugation to exhibit an MBB thickness of 200 μm.

In some embodiments, the thickness of the MBB of the member having corrugated augmentation ranges from 6 μm to 5,000 μm.

In some embodiments, including any of the foregoing, the augmented metallic foil that is produced by a continuous corrugation process, is provided in the form of a roll of the foil, wherein the foil's width, or the roll's width is at least 0.1 m, at least 0.5 m, at least 1 m, at least 2 m, at least 3 m, at least 4 m, or at least 5 m wide, and having a length of at least 0.5 m, 1 m, 10 m, 100 m, 200 m, 300 m, or 400 m long.

### Perforated Current Collectors:

In some embodiments, the current collector comprises or consists of an augmented metallic foil characterized by perforation augmentation, which is produced by a continuous electroforming process. In some embodiments, the CC that is produced by a continuous electroforming process, comprises or consists of copper. In some embodiments, the augmented metallic foil that is produced by a continuous electroforming process, is perforated by means of electroforming the same on a curved surface of a conductive cylinder having an SRP of a non-conductive material engraved or set into the surface of the cylinder. In some embodiments, the augmented metallic foil that is produced by a continuous electroforming process to exhibit an SRP of perforation textural elements, as presented herein, and optionally corrugated to exhibit an SRP of corrugation textural elements, as presented herein.

In some embodiments, the current collector that is produced by a continuous electroetching process, comprises or consists of aluminum. In some embodiments, the current collector that is produced by a continuous electroetching process, comprises or consists of copper. In some embodiments, the augmented metallic foil that is produced by a continuous electroetching process, is perforated by means of electroetching the same using on a mask having an SRP. In some embodiments, the augmented metallic foil that is produced by a continuous electroetching process, is further corrugated to exhibit an SRP of corrugation textural elements, as presented herein.

In some embodiments, the perforated member, forming a part of or constituting a current collector, is also corrugated.

In some embodiments, including any of the foregoing, the augmented metallic foil that is produced by a continuous electroetching or a continuous electroforming process, and exhibiting perforation augmentation only or exhibiting perforation as well as corrugation augmentation, as described hereinabove, is provided in the form of a roll of the object, wherein the object's width, or the roll's width is at least 0.1 m, at least 0.5 m, at least 1 m, at least 2 m, at least 3 m, at least 4 m, or at least 5 m wide, and having a length of at least 0.5 m, at least 1 m, at least 10 m, at least 100 m, at least 1000 m, or at least 10,000 m long.

### Electrode:

As discussed hereinabove, the advantages gained by the augmented metallic foil provided herein, compared to the presently used pristine solid (non-porous) and flat (planar, smooth) metal foils, include reducing mass of the electrode, increasing the amount of active material that can be loaded per unit area, increasing the surface area of contact with the active material, improving electric path within the active material, and all of that while maintaining low production costs and compatibility with mass production machinery and processes.

The members and CCs provided herein contribute to the significant reduction of local current densities by enlarging the surface area of the CCs. Because lowering the current density at the electrode can retard the onset of dendritic growth and slow down the growth rate, the CCs provided herein effectively alleviate dendritic growth. In addition, because the CCs act as hosts for Li metal, the presently provided CCs block randomly generated Li metal-electrolyte interphases and internal pressure changes due to the volume changes of Li metal during cycling.

Compared to other 3D porous metal sheets that have been proposed and demonstrated in the art, the present invention provides a solution to the extreme high costs, lengthy manufacturing time, and most profoundly, the present invention provide a solution to the very limited production capacity of all other 3D porous structures, which cannot be produced in large volumes into tens- and hundreds of meters-long rolls, which are required by contemporary electrode coating production in mass production factory facilities. The member provided herein, as well as the current collector comprising or consisting of the same, can be implemented in electrode production in the form of continuous rolls of feed foil that is being fed into the active material coating devices, later to be cut into individual electrodes.

Thus, according to some embodiments of the present invention, there is provided an electrode, e.g., in the context of a battery or a capacitor, that includes at least one current collector, and an active electrode material (a.k.a., coating material) disposed on the CC, wherein the current collector includes at least one, or consists of the augmented metallic foil (member) provided herein. Herein throughout, the term “electrode” refers to both anodes and cathode, unless stated otherwise explicitly.

Electrode coating is a significant part of battery manufacturing process, with a large contribution to the final microstructure and thus pertinent to the functioning of the resulting electrode. According to embodiments of the present invention, coating of the augmented metallic foil provided herein can be performed via various routes, whereas the coater device may be a draw down coater, which is commonly used in research labs to produce small coatings, or for larger, industrial applications, a roll-to-roll (a.k.a., R2R or reel-to-reel) coater, for which the presently disclosed member is most suitable. In a roll-to-roll setup, the geometry of the coater, used to coat the member according to some embodiments of the present invention, can be doctor blade (a fine blade set at a fixed gap from the CC), comma bar (a comma shaped geometry with a curved leading edge), slot die (coating material is extruded out of a slot onto the CC), “knife-over-roll” (coating material is dispensed to the CC, which then passes through a knife and roller), “reverse roll”, “Meyer rod” (wherein a roller applies the coating material to the CC, and then a Meyer bar meters out the correct amount), as these methods and devices are known in the art. The coating may be applied while the CC is supported by a roller, or it can also be applied to an unsupported CC under tension, which is known as tensioned web coating. Other electrode coating processes known in the art may be used to coat a current collector, set forth herein.

The coating materials are introduced directly onto the CCs without additional morphological deformation of the CCs, and can be introduced on one side of the member, or on both sides thereof, depending on the battery design requirements. For example, a corrugated member, as provided herein, has been used in an industrial electrode coating machine to successfully produce electrode for LiBs, which demonstrate the possibility of large-scale production and applicability to practical industries. This simple manufacturing process can also be linked to its cost-effective properties.

Thus, according to some embodiments of the present invention, the electrode is produced by any known R2R process, using a roll of the augmented metallic foil provided herein.

In some embodiments, the thickness of the electrode including the coating material is greater than the total thickness (MBB thickness) of the current collector, due to the added layer(s) of coating material disposed thereupon. In some embodiments, the thickness of the electrode including the coating material is similar to the total thickness (MBB thickness) of the current collector, including the added layer(s) of coating material disposed thereupon.

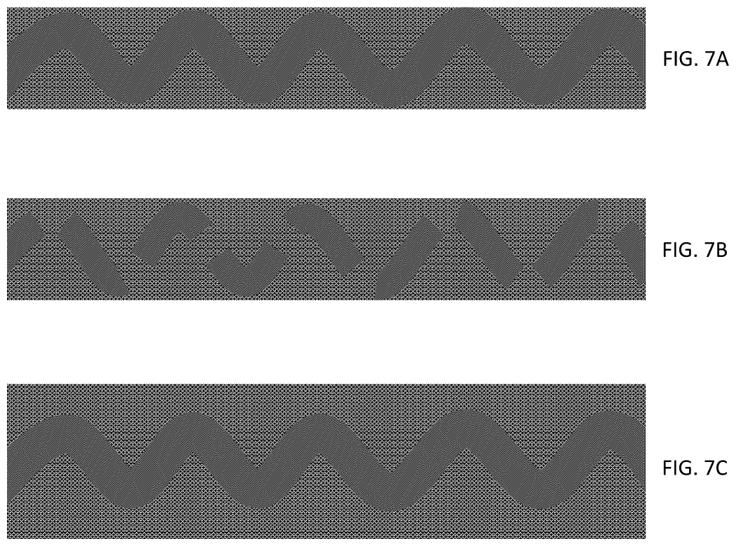

FIGS. 7A-C present schematic illustrations of coating schemes of an augmented metallic foil, according to some embodiments of the present invention, wherein the top cross-sectional illustration (FIG. 7A) shows an electrode that exhibits the same thickness as the total thickness (MBB thickness) of a corrugated foil member, similar to the middle illustration (FIG. 7B) that shows a perforated and corrugated member, and the bottom illustration (FIG. 7C) shows an electrode that exhibits a greater thickness compared to the total thickness (MBB thickness) of a corrugated member.

In some non-limiting embodiments wherein the thickness of the electrode is similar to the thickness of the current collector, the thickness of the CC is 9-12 μm, or up to 100 μm. In some non-limiting embodiments wherein the thickness of the electrode is thicker than the thickness of the current collector, the current collector has 50 μm holes on its surface, and a porosity is higher than 90%, afforded by corrugation and/or perforation.

As discussed herein, a current collector may comprise more than one metallic layers, wherein at least one of the layers is the augmented metallic foil provided herein, or all.

### Coating Material:

Since the augmented metallic foil provided herein is designed to be suitable for contemporary industrial electrode production, all known and commonly used processes, methodologies and techniques for producing and applying active coating materials onto current collectors, apply and are useful for use therewith.

In some embodiments, the processes include coating a current collector with wet or fluid active material composition, in the form of a slurry, a paste, a liquid and the likes. In some embodiments, the coating is afforded by dry (solventless) coating in which the active material is deposited onto a current collector with little or no use of a solvent to carry the active material.

### Electrode Comprising a Corrugated Current Collector:

According to some embodiments of the present invention, there is provided an electrode, that includes at least one current collector, and an active electrode material disposed on the CC, wherein the current collector includes at least one, or consists of the augmented metallic foil (member) in the form of corrugated metal foil, as presented hereinabove. In some embodiments, the member is not perforated.

### Electrode Comprising a Perforated and Optionally Also Corrugated Current Collector:

According to some embodiments of the present invention, there is provided an electrode, that includes at least one current collector, and an active electrode material disposed on the CC, wherein the current collector includes at least one, or consists of the augmented metallic foil (member) in the form of perforated metal foil, as presented hereinabove. In some embodiments, the perforated member is also corrugated, as described hereinabove.

### Batteries and Electric Devices:

In view of the forgoing, there is provided a cell or a battery, that includes at least one electrode, wherein the electrode comprises at least one augmented metallic foil as provided herein, or wherein the electrode comprises a current collector that includes at least one, or consists of the augmented metallic foil (member; object) provided herein. It is noted herein that while a cell is a single unit of device that converts chemical energy into electrical energy, and a battery is a collection of cells that converts chemical energy into electrical energy, the terms “cell” and “battery” are used herein interchangeably.

Correspondingly, there is provided am electric device that includes the cell, an array of cells, the battery or an array of batteries, as provided herein.

In some embodiments, the cell or the battery includes at least one electrode that includes at least one current collector, wherein the CC is a corrugated metallic foil, or a corrugation-augmented metallic foil, as described herein.

In some embodiments, the cell or the battery includes at least one electrode that includes at least one current collector, wherein the CC is a perforation-augmented metallic foil, or a perforation-augmented metallic foil, as described herein.

In some embodiments, the cell or the battery includes at least one electrode that includes at least one current collector, wherein the CC is a perforated and corrugated metallic foil, or a metallic foil augmented by both perforation and corrugation, as described herein.

The electric devices which are contemplated within the scope of the present invention, include any electric device that can use a cell or a battery as a main, auxiliary or minor source of energy. Alternatively, an electric device is one that includes at least one battery, wherein the device uses the electricity stored in the battery as its power source.

Examples of electric devices include, without limitation, an electric vehicle for transportation in air, land, water and/or space, a smartphone, a laptop computer, a portable media player, a power tool, a toy, a heating device, a colling device, an article for illumination (e.g., flashlight), and the likes.

In some embodiments, the electric device is a device that requires batteries with high power density, such as a vehicle (e.g., electric car). In the context of a battery, power density refers to the amount of power that can be stored or delivered by the battery per unit volume or unit mass. High power density means that a battery has the ability to store or deliver a relatively large amount of power in a relatively small space or weight. This is one of the characteristics for batteries using the augmented metallic foil provided herein, which is designed for use in portable electronic devices and electric vehicles, where size and weight are critical factors. High power density batteries can also have a higher energy density, which means they can store more energy per unit weight or volume.

It is expected that during the life of a patent maturing from this application many relevant augmented metallic foils will be developed and the scope of the phrase “augmented metallic foil” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions, illustrate some embodiments of the invention in a non-limiting fashion.

### Example 1

### Corrugation Augmentation

Copper and aluminum foils having a local thickness of 12 μm and 60 μm, respectively, and at least 125 m long, were subjected to a roll-to-roll corrugation augmentation process as described herein. The SRP of non-piercing textural elements consisted of round depressions spaced apart by horizontal distance of about 500 μm and arranged in a hexagonal array, bringing the total thickness after corrugation (MBB thickness) to 60 μm in copper, and 190 μm in aluminum.

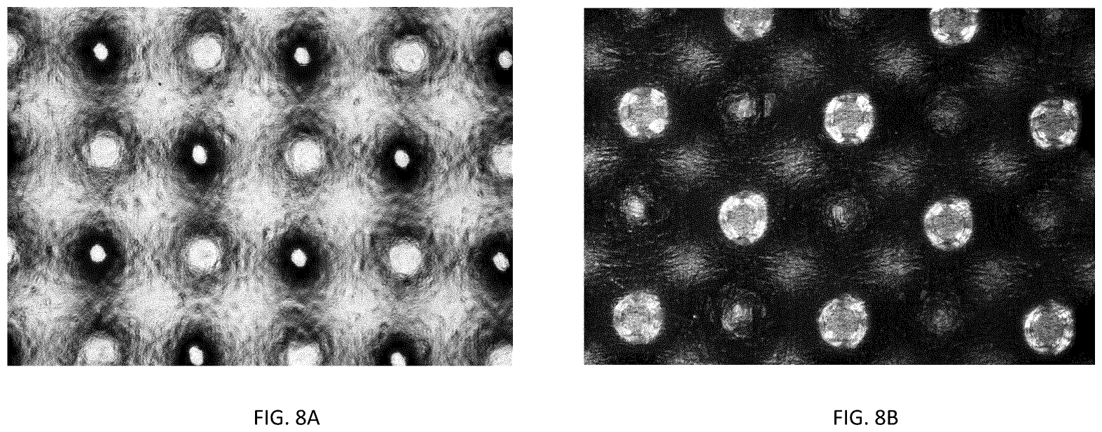

FIGS. 8A-B present micrographs acquired using Nikon eclipse LV100ND optical microscope, taken for an augmented metallic foil made of a 12 μm thick copper foil (FIG. 8A) and a 60 μm thick aluminum foil (FIG. 8B), each undergone corrugation augmentation in the form of hexagonally-arranged circular depressions horizontally spaced by about 500 μm apart from each other.

### Example 2

### Perforation and Corrugation Effect on Functional Porosity

To demonstrate the effect of both perforation and corrugation of a pristine metal foil, the same aluminum foil used in Example 1 was subjected to perforation by electroetching and corrugation augmentation as described in Example 1. The perforation was carried out in the form of a hexagonal array of round through-holes, each positioned in the center between four adjacent depressions, thereby constituting an SRP of round through-holes.

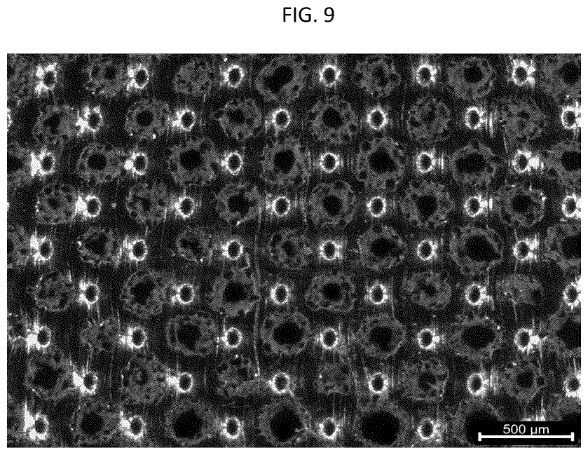

FIG. 9 presents a photograph acquired using Leica DVM6 optical microscope, taken for a 60 μm thick aluminum foil undergone perforation and corrugation augmentations in the form of hexagonally-arranged circular holes and depressions horizontally spaced by about 500 μm apart from each other, respectively.

The resulting total (MBB) thickness of the augmented metallic foil was increased from 60 μm 100 μm, and the resulting functional porosity was greater than, or equal, to 90%, according to the bounding box calculation.

### Example 3

### Active Material Coating

To demonstrate the capacity of the augmented metallic foil provided herewith to be loaded with electrode active material, the corrugated aluminum foil presented in Example 1 hereinabove was used as a current collector, and coated with a cathode active material slurry comprising 95 Wt. % NMC811 (LiNi_{0.8}Mn_{0.1}Co_{0.1}O₂), 3 wt. % poly(vinylidene fluoride) (PVDF), C65 (nano carbon black conductive additive; 2 wt. %), suspended in NMP(N-methyl-2-pyrrolidone slurry carrier).

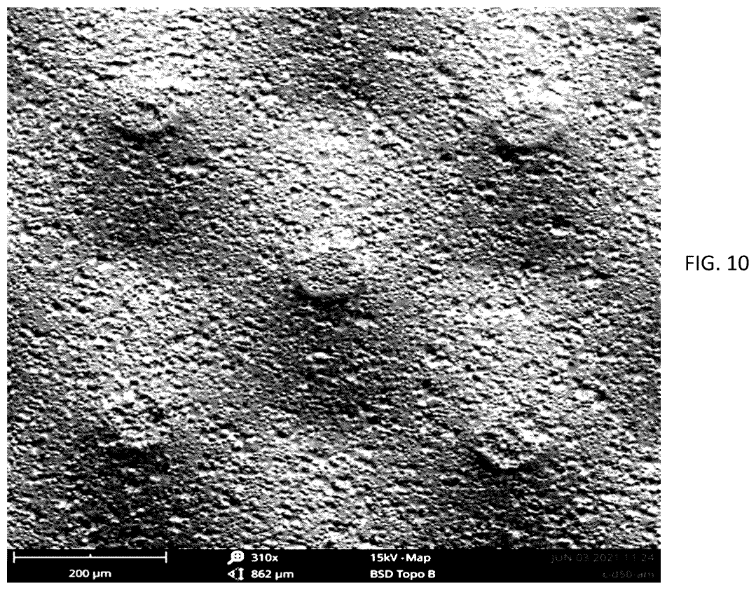

The slurry was applied onto the aluminum current collector member using a draw down coater, and dried, thereby forming an exemplary cathode, according to some embodiments of the present invention. Thereafter, the aluminum was chemically etched from the cathode to afford a residual layer of dried active material having the formation shown in FIG. 10.

FIG. 10 presents a photograph acquired using Leica DVM6 optical microscope, taken for the dried layer of slurry applied on a corrugated aluminum foil, or a member according to some embodiments of the present invention, after the aluminum had been removed by acid etching, showing five protruding bumps and four depressions pointing to the opposite side.

A similar experiment was conducted for a different slurry, comprising LiFePO₄, which was coated and dried on a similar corrugated aluminum foil.

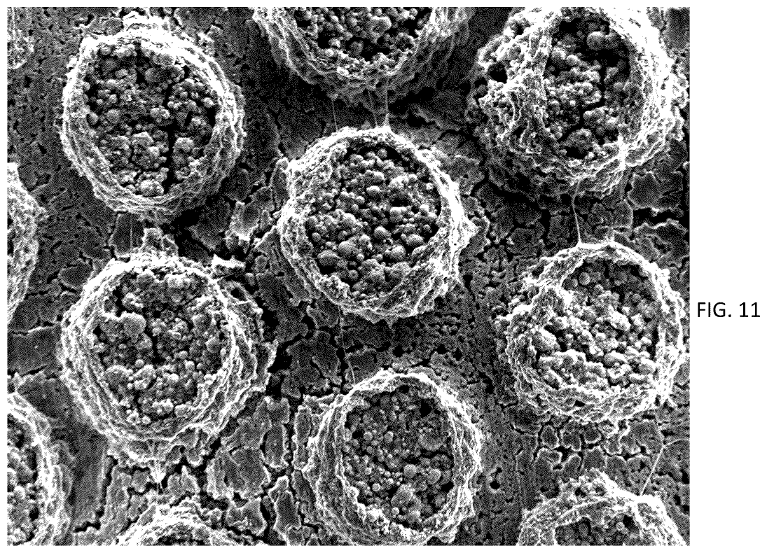

FIG. 11 presents a photograph acquired using Leica DVM6 optical microscope, taken for the dried layer of slurry applied on a perforated member made of aluminum, according to some embodiments of the present invention, after the aluminum had been removed by acid etching, showing several round protrusions made of active material which have formed in the voids where holes in the member used to be.

As can be seen in FIG. 11, the columnar structures are formed due to the SRP of holes of the perforated aluminum member.

### Example 4

### Lithium-Ion Cells Containing Corrugated Current Collectors

Multilayer lithium-ion pouch cells with capacity range 1-1.5 Ah were prepared using a corrugated copper and aluminum foils as current collectors, according to some embodiments of the present invention, wherein the anode was prepared using the corrugated copper foil and the cathode was prepared using the corrugated aluminum foil, according to some embodiments of the present invention.

The cells included a graphite anode and Nickel-Manganese-Cobalt (NMC622) cathode as these are known in the art, with a cathode active material composition of 94 wt. % NMC622, 2 wt. % PVDF, 2 wt. % C65 (carbon black conductive additive), and the slurry carrier was N-methyl pyrrolidone (NMP) with a standard electrolyte of 1M LiPF6, EC/December 1:1. Active material was coated on the current collector using standard roll to roll machinery, and cells were otherwise assembled using standard cell assembly practices.

The copper current collector used for the anode was 12 μm in local thickness, with a MBB thickness of 43.5 μm, and a hexagonal array of round depressions spaced apart by a horizontal distance of 500 μm. The aluminum current collector used of the cathode was 20 μm in local thickness and a MBB thickness of 63.2 μm, and a hexagonal array of round depressions spaced apart by a horizontal distance of 500 μm.

The cathode active area was 6×10 cm². The pouch cells first went through a formation step at C-rate of C/20 prior to cycle testing. Following the formation, the cell was subjected to charge-discharge cycles at 1C (with periodic capacity check at C/3) at room temperature.

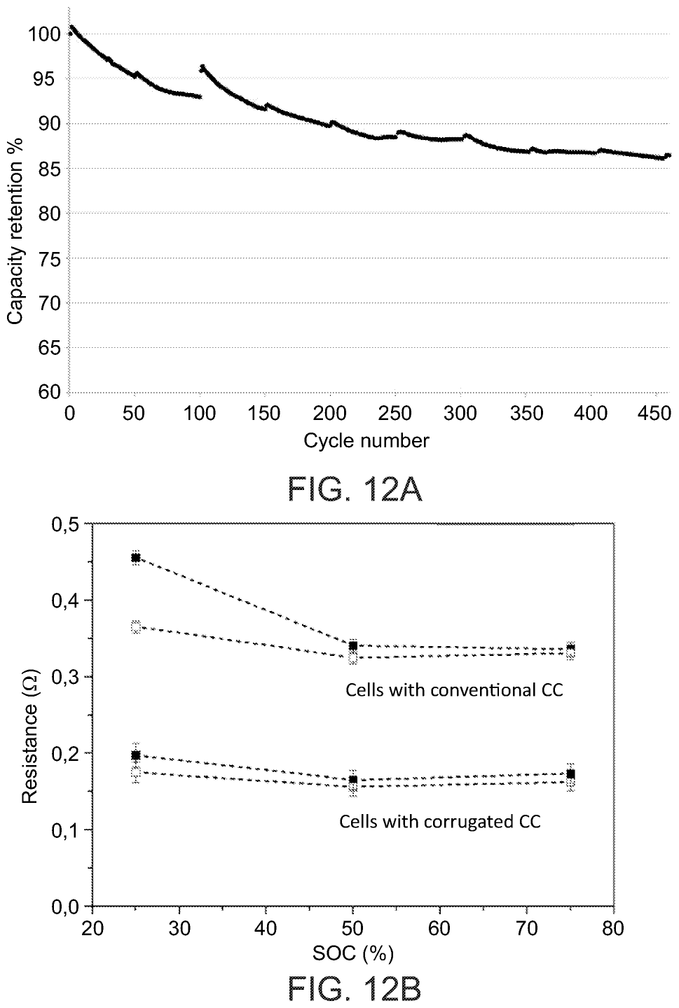

The results of cycling are presented in FIG. 12A where the capacity retention of the cells is plotted versus cycle number with initial capacity of 1.1 Ah at 100%. The cells were able to cycle at high 1C rate for more than 450 cycles having 85% of initial capacity left.

In order to compare the direct current internal resistance (DCIR) of a pouch cell with corrugated current collectors relative to the ones with conventional electrodes, a GITT method was utilized as in the previous example. The internal resistance of the cells was measured at three different SOC during the cell discharge. FIG. 12B shows the comparison of DCIRs as a function of a SOC between two configurations.

FIGS. 12A-B present the battery cycling results obtained for lithium-ion cells comprising corrugated current collects, according to some embodiments of the present inventio, wherein FIG. 12A presents the measurement of retained capacity of the cell constructed using a corrugated CC as provided herein (scale of capacity is as a percentage of initial capacity), and FIG. 12B presents the measurement of internal resistance of the cell at various states of charge, while comparing the results to those obtain for a similar cell comprising conventional (flat, non-porous) current collectors.

Lowering the internal resistance of battery cells has a significant effect on overall battery performance as it allows for faster charging and discharging, and doing so with fewer losses to overall capacity retention. As can be seen in FIGS. 12A-B, the performance of the cells, constructed according to some embodiments of the present invention, is superior to the performance of cells using convection foils for CC. As seen, the cell with corrugated CCs in the electrodes exhibited a lower DCIR (more than twice) when compared to the cells with conventional electrodes.

### Example 5

### Perforation Augmentation

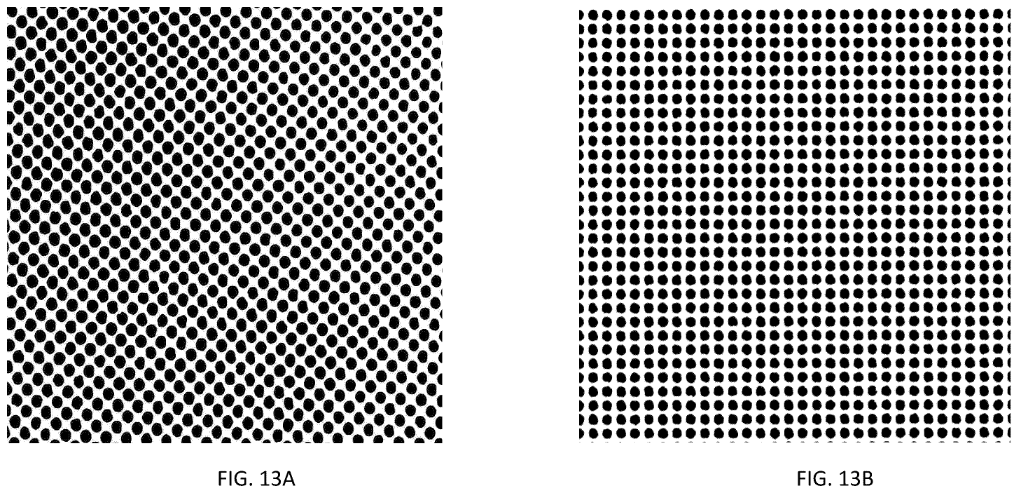

FIGS. 13A-B present optical scans of 0.53 cm² samples of a perforated and flat (non-corrugated) augmented foils, manufactured using one of the continuous manufacturing processes described herein, wherein FIG. 13A shows an aluminum object having a local thickness of 20 μm, and an SRP consisting of a round through-hole motif with an average radius of 55.1 μm and standard deviation of 2.4 μm (uniformity of the SRP of 4.4% SD), and FIG. 13B shows a copper object having a local thickness of 22 μm, and an SRP consisting of a round through-hole motif with an average radius of 58.9 μm and standard deviation of 1.4 μm (uniformity of the SRP of 2.4% SD). In the copper object the number of holes found in the sample's area was 930 which took 35% of the total area of the sample.

The perforated copper metallic member exhibited a tensile strength of about 50 MPa, and the perforated aluminum metallic member exhibited a tensile strength of about 45 MPa.

Dimensional analysis of the objects was carried out using an Epson Perfection V850 Pro Scanner and Image Expert software to calculate key metrics related to the SRP.

Table 1 represents data collected to measure the uniformity of the SRP, wherein the area average refers to the average of the samples' area, the radius average refers to the average value of the holes' radii, and roundness refers to the average measure of holes' roundness.

TABLE 1

| | Area | Area StDev | Radius | Radius | Roundness |
|---|---|---|---|---|---|
| | Average | [μm²] | Average [μm] | Average | Average |
| Material | [μm²] | (SD %) | (SD μm) | SD (%) | (SD %) |
| Al | 9270 | 778 (8.4%) | 55.1 (2.4) | 4.4% | 0.98 (2%) |
| Cu | 10485 | 513 (4.9%) | 58.9 (1.4) | 2.4% | 0.98 (2%) |

### Example 6

### A Lithium-Ion Battery Containing Porous and Corrugated Current Collectors

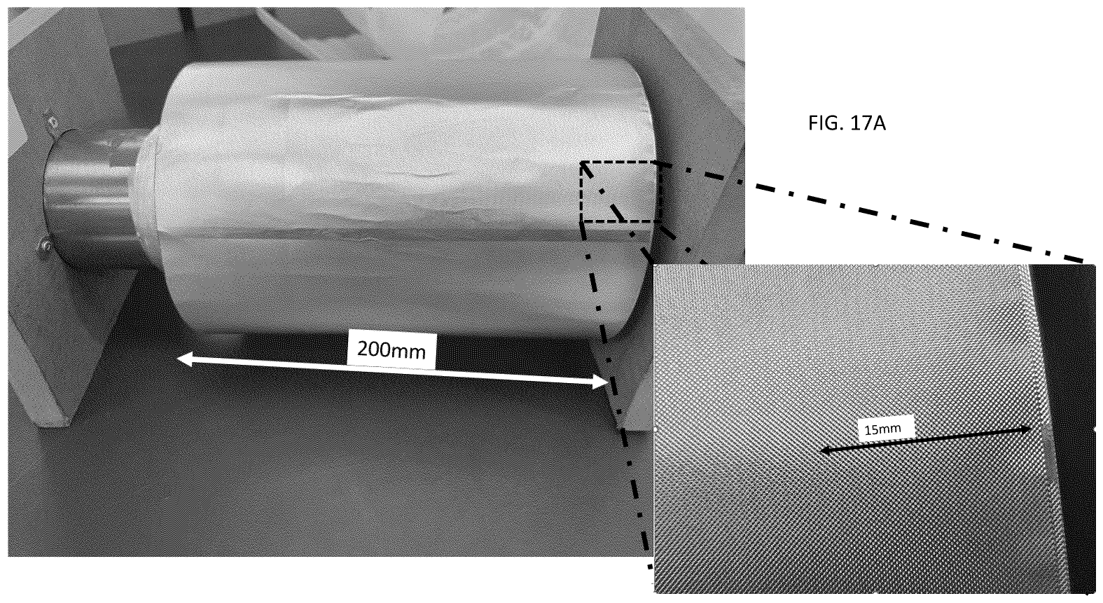

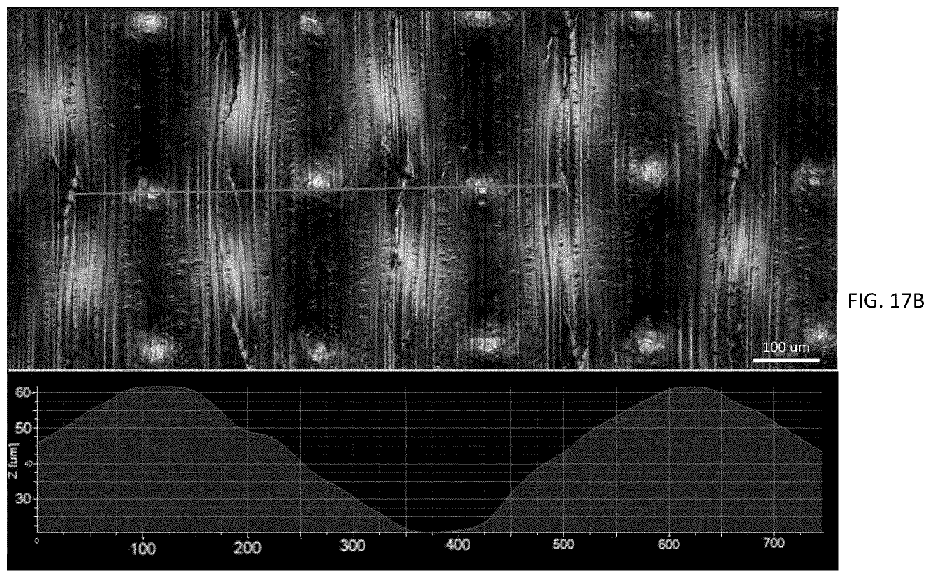

A single layer pouch cells were prepared having an anode and a cathode produced according to some embodiments of the present invention. The local thickness of the copper CC used for the anode was 18 μm, with a MBB thickness of 100 μm, and a SRP motif of one square shaped through-hole of 50 μm in size (see, FIG. 17A). The local thickness of the aluminum CC used of the cathode was 100 μm with a MBB thickness of 200 μm, and a SRP motif of a round through-hole with a radius of 90 μm (see, FIG. 17B).

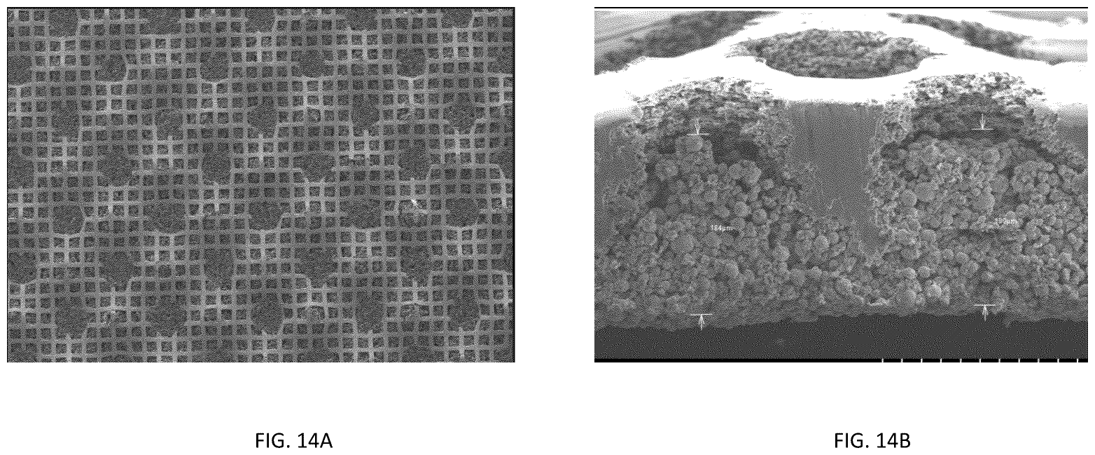

FIGS. 14A-B present SEM micrographs of a corrugated and perforated objects, showing a top view of a copper current collector having active material coated on one side thereof for demonstration purposes (FIG. 14A) and cross-section of an aluminum current collector (FIG. 14B).

The cell included a graphite anode and the LiFePO4 (LFP) cathode, with a cathode active material composition of 90 wt. % LFP, 5 wt. % PVDF, 5 wt. % C45 (carbon black conductive additive), and the slurry carrier was N-methyl pyrrolidone (NMP). The cathode active area was 4×4 cm². The pouch cell forming step included a first cycle of charge and discharge. A standard electrolyte of 1M LiPF6, EC/December 1:1 was used.

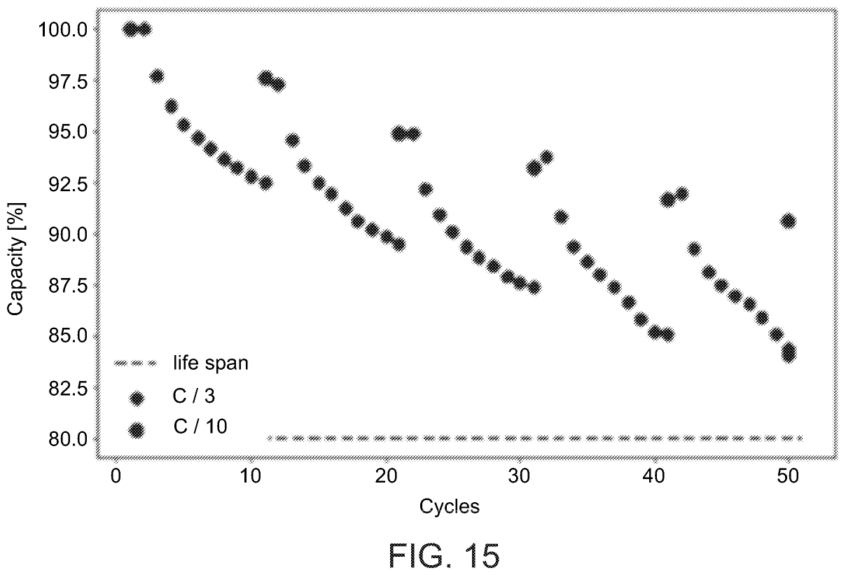

The pouch cell first went through a formation step at C-rate of C/30 prior to cycle testing. Following the formation, the cell was subjected to over 50 charge-discharge cycles at C/3 (with periodic capacity check at C/10) at room temperature. The results of cycling are presented in FIG. 15.

FIG. 15 presents a plot of the capacity retention versus cycle number with initial capacity of 35 mAh at 100%, measured in lithium-ion cells produced with perforated and corrugated CCs, according to some embodiments of the present invention.

In order to compare the direct current internal resistance (DCIR) of the pouch cell with perforated and corrugated CCs versus a pouch cell constructed with conventional (pristine foil) current collectors, a Galvanostatic Intermittent Titration Technique (GITT) method was utilized.

GITT(is a common procedure to measure battery internal resistance using current pulses. Briefly, GITT involves step-wise discharge (or charge) of batteries at known state of charge (SOC) and running a current pulse to estimate a cell resistance based on differences between initial voltage (before the pulse) and the voltage measured at the end of the pulse over the applied current

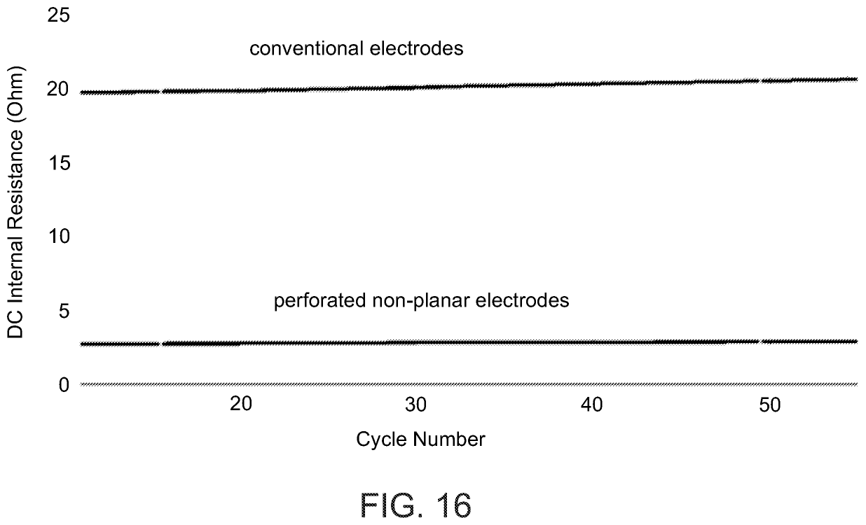

The internal resistance of the cell was measured at four different SOCs during the cell discharge, and the average of these measurements was taken as a cell DC internal resistance, and the results are presented in FIG. 16.

FIG. 16 is a comparative plot showing the DCIRs as a function of a cycle life between two configurations, a cell constructed with conventional (pristine foil) CC, and a cell constructed with an augmented metallic foil, as provided herein.

As can be seen in FIG. 16, the cell with perforated and corrugated CCs in the electrodes maintained a lower DCIR (more than four times) over all the cycles, compared to the performance of conventions CCs.

In addition to showing reduced internal resistance compared to the cell with conventional foils, the cell with perforated and corrugated CCs exhibited enhanced capacity retention during the cycling of the cell. When compared to the cell with conventional current collectors, degradation rate (capacity loss over the cycles) of the cell with perforated and corrugated current collectors was significantly lower as indicated by the higher capacity retention, as summarized in Table 2.

TABLE 2

| | Capacity at | Capacity at | |
|---|---|---|---|
| | First Discharge | Last Discharge | Capacity |
| CCs type in cell | (mAh) | (mAh) | Retention |
| Pristine foil CCs | 24.20 | 17.09 | 70.6% |
| Perforated and | 35.03 | 31.75 | 90.6% |
| Corrugated CCs | | | |

As can be seen in Table 2, the cells constructed with CCs designed and obtained according to some embodiments of the present invention, exhibited a higher capacity retention, compared to cells constructed with pristine foil CCs. Having higher capacity retention after cycling of cells indicates an improvement to overall cycle life by lowering the rate of degradation. Such an improvement can allow for batteries to last longer and perform better.

### Example 7

### Exemplary Textural Elements and Corresponding SRPs

Table 3 presents combinations of various SRP parameters of a perforation augmentation.

TABLE 3

| | | | | | No. of | | |
|---|---|---|---|---|---|---|---|
| | Local | | | | holes | Vertical | |
| Metal | thickness | | Hole size | | per mm² | distance | |
| Copper | 4 | μm | 10-30 | μm | 400-300 | 10-50 | μm |
| Copper | 10 | μm | 30-60 | μm | 300-200 | 50-100 | μm |
| Copper | 20 | μm | 60-90 | μm | 200-100 | 100-150 | μm |
| Copper | 50 | μm | 90-120 | μm | 100-50 | 150-200 | μm |
| Aluminum | 4 | μm | 10-30 | μm | 400-300 | 10-50 | μm |
| Aluminum | 10 | μm | 30-60 | μm | 300-200 | 50-100 | μm |
| Aluminum | 20 | μm | 60-90 | μm | 200-100 | 100-150 | μm |
| Aluminum | 50 | μm | 90-120 | μm | 100-50 | 150-200 | μm |

Table 4 presents combinations of various SRP parameters of a corrugation augmentation.

TABLE 4

| | | | |
|---|---|---|---|
| | Local | MBB | Horizontal |
| Metal | thickness | Thickness | Distance |

| | | | | | | |
|---|---|---|---|---|---|---|
| Copper | 8 | μm | 4-30 | μm | 320-1000 | μm |
| Copper | 10-12 | μm | 20-60 | μm | 300-200 | μm |
| Copper | 20 | μm | 20-120 | μm | 200-100 | μm |
| Copper | 50 | μm | 90-120 | μm | 100-50 | μm |
| Aluminum | 20 | μm | 30-60 | μm | 320-1000 | μm |
| Aluminum | 30 | μm | 30-90 | μm | 320-1000 | μm |
| Aluminum | 60 | μm | 90-180 | μm | 500-1000 | μm |
| Aluminum | 125 | μm | 130-500 | μm | 500-2000 | μm |

### Example 8

### Rolls of Augmented Metallic Foils

FIGS. 17A-B presents photographs of an augmented metallic foil (metallic member), according to some embodiments of the present invention, comprising aluminum and exhibiting corrugation augmentation, wherein the local thickness is about 20 μm, the vertical distance (height) of the round budges (non-piercing textural elements) is about 72 μm, which is also the MBB thickness, the horizontal distant between textural elements is about 500 μm, wherein an entire roll of the augmented metallic foil is presented in FIG. 17A with a close-up insert, and the microscopic image showing the corrugation textural elements in FIG. 17B.

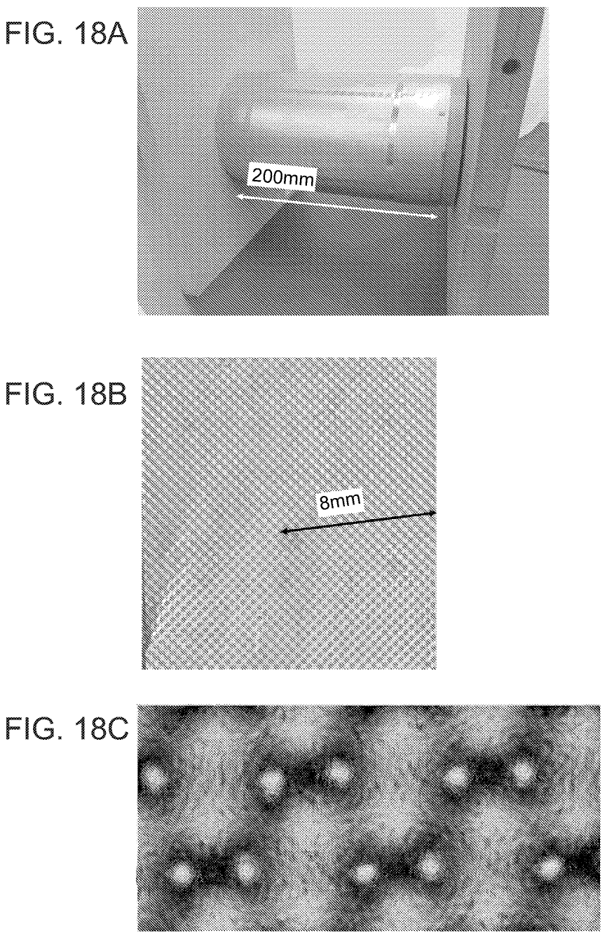

FIGS. 18A-C presents photographs of an augmented copper foil, according to some embodiments of the present invention, exhibiting corrugation augmentation, wherein the local thickness is about 12 μm, the MBB thickness is about 100 μm, the horizontal distant between textural elements is about 500 μm, wherein an entire roll of the augmented metallic foil is presented in FIG. 18A, a close-up insert in FIG. 18B, and the microscopic image showing the corrugation textural elements in FIG. 18C.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1.-25. (canceled)

26. An object comprising a metallic member, said metallic member is characterized by a seamless repeating pattern of through-hole textural elements, and at least one of:
(a) a seamless repeating pattern of non-piercing textural elements;
(b) a local thickness that ranges 3-100 μm; and
(c) a functional porosity (P_{f}) of at least 10%.

27. The object of claim 26, wherein said metallic member is characterized by (a).

28. The object of claim 26, wherein said metallic member is at least 0.1 m in width and at least 0.5 m in length.

29. The object of claim 26, wherein said metallic member is characterized by (a), (b) and (c).

30. The object of claim 26, wherein said metallic member comprises a metal selected from the group consisting of aluminum, copper, nickel, gold, cobalt, iron, titanium, steel, stainless steel, and any alloys and combination thereof.

31. The object of claim 26, wherein said local thickness ranges 3-20 μm.

32. The object of claim 26, wherein said functional porosity is at least 50%.

33. The object of claim 26, wherein said through-hole textural elements in said seamless repeating pattern have an opening size that ranges 10-200 μm.

34. The object of claim 26, wherein said through-hole textural elements in said seamless repeating pattern have a pore density that ranges 30-200 holes/mm².

35. The object of claim 26, wherein said seamless repeating pattern is characterized by uniformity of at least 5%.

36. The object of claim 26, characterized by a tensile strength of at least about 45 MPa.

37. The object of claim 26, wherein said metallic member comprises isolated non-piercing textural elements comprising bulges and depressions protruding on both sides of the metallic member, wherein said isolated textural elements are aligned in tilted lines, and/or wherein the seamless repeating pattern of through-hole textural elements comprises a hexagonal array of round through-holes.

38. The object of claim 26, wherein:
said metallic member comprises copper,
said seamless repeating pattern of through-hole textural elements comprises a motif of a round hole having a diameter of less than about 250 μm and a horizontal distance of less than 500 μm,
said seamless repeating pattern of non-piercing textural elements comprises a motif of a round depression and/or a round bulge each having a diameter of less than 500 μm and a horizontal distance of less than 1000 μm,
said local thickness is less than 50 μm, and
said functional porosity (P_{f}) is at least 50%.

39. The object of claim 26, wherein:
said metallic member comprises aluminum,
said seamless repeating pattern of through-hole textural elements comprises a motif of a round hole having a diameter of less than about 250 μm and a horizontal distance of less than 1,000 μm,
said seamless repeating pattern of non-piercing textural elements comprises a motif of a round depression and a round bulge each having a diameter of less than 500 μm and a horizontal distance of less than 1000 μm,
said local thickness is less than 100 μm, and
said functional porosity (P_{f}) is at least 50%.

40. A roll comprising a cylindrical core and the object of claim 26 wound around said core, wherein a width of said object is at least 0.1 m and a length of said object in the roll is at least 10 m.

41. A current collector, comprising at least one object according to claim 26.

42. An electrode comprising a current collector obtained by cutting the at least one object according to claim 41.

43. A battery comprising at least one electrode according to claim 42.

44. The battery of claim 43, comprising at least one electrode comprising nickel manganese cobalt oxide or LiFePO₄, wherein said metallic member comprises aluminum, and at least one electrode comprising graphite, wherein said metallic member comprises copper.

45. An electric device comprising at least one battery according to claim 43, the electric device selected from the group consisting of an electric vehicle for transportation in air, land, water and/or space, a smartphone, a laptop computer, a media player, a power tool, a toy, a heating device, a colling device and an illumination device.
